(19) United States
(12) Patent Application Publication
(10) Pub. No.: US 2017/0373950 A1
(43) Pub. Date: Dec. 28, 2017

(54) TRAFFIC FLOW MONITORING

(71) Applicant: NOKIA SOLUTIONS AND NETWORKS OY, Espoo (FI)

(72) Inventors: Peter SZILAGYI, Budapest (HU); Csaba VULKAN, Budapest (HU)

(21) Appl. No.: 15/543,642

(22) PCT Filed: Jan. 27, 2015
(86) PCT No.: PCT/EP2015/051563

§ 371 Date: Jul. 14, 2017

(51) Int. Cl. H04L 12/26; H04L 12/853; H04L 12/851

(52) U.S. Cl. CPC H04L 43/026; H04L 47/2416; H04L 47/2483

(57) ABSTRACT

A method is provided comprising monitoring, in a network node, a user plane traffic flow transmitted in a network, to perform measurements on selected data packets. Based on the monitoring, the network node collects in a correlated way, one or more of user measurement data, application measurement data, quality of experience measurement data, network side quality of service measurement data and a set of key performance indicators. Based on the collecting, the network node generates real-time correlated insight to customer experience.

### TECHNICAL FIELD

The invention relates to communications.

### BACKGROUND

In wireless telecommunication systems such as 3GPP HSPA, LTE or 5^{th} generation (5G) networks as well as in fixed access networks, the objective of a customer experience (CE) management is to provide each application session with the required amount of systems resources while using the system resources efficiently, i.e., to maximize the customer experience. Managing the QoE requires a correlated insight and measurements to the applications, the customer experience user behaviour, network status and quality of service.

### BRIEF DESCRIPTION

According to an aspect, there is provided the subject matter of the independent claims. Embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following, the invention will be described in greater detail by means of preferred embodiments with reference to the accompanying drawings, in which

FIG. 1 illustrates a wireless communication system to which embodiments of the invention may be applied;

FIG. 2 is a signalling diagram of a procedure for traffic flow monitoring according to an embodiment of the invention;

FIG. 3 illustrates a process for flow-based monitoring and measurements according to an embodiment of the invention;

FIG. 4 illustrates obtaining and aggregating of individual and cooperative flow-based measurements;

FIG. 5 illustrates a process for obtaining correlated QoE, user behaviour, application and network side QoS insight according to an embodiment of the invention;

FIG. 6 illustrates deployment options for a customer experience CE agent;

FIG. 7 illustrates use cases for a CE agent and inter-CE agent interactions;

FIG. 8 illustrates a flow descriptor and attributes parsed from application layer packet headers;

FIG. 9 illustrates per packet monitoring actions;

FIG. 10 illustrates individual and collaborative per-flow QoS measurements;

FIG. 11 illustrates collaborative measurements and real-time status updates between CE agents;

FIG. 12 illustrates QoS measurements executed by CE agents for TCP flows;

FIG. 13 illustrates indirect localization of packet loss at a core side CE agent;

FIG. 14 illustrates one-way delay measurement in a downlink direction with two CE agents;

FIG. 15 illustrates one-RTT correlated measurement of multiple KPIs;

FIG. 16 illustrates application-specific QoE measurements;

FIG. 17 illustrates a delay profile on a network segment;

FIG. 18 illustrates congestion localization and outlier detection;

FIG. 19 illustrates the skewness of delay distribution;

FIG. 20 illustrates distributed radio side CE agent deployment;

FIG. 21 illustrates core side stand-alone CE agent deployment;

FIG. 22 illustrates combined CE agent deployment;

FIG. 23 illustrates an in-line core side CE agent vs. a tapping core side CE agent;

FIG. 24 illustrates a 3G BTS/RNC-specific CE agent implementation;

FIG. 25 illustrates a Wi-Fi-specific CE agent implementation;

FIG. 26 illustrates control plane measurements on an LTE S1-MME interface;

FIG. 27 illustrates a blocks diagram of an apparatus according to an embodiment of the invention.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

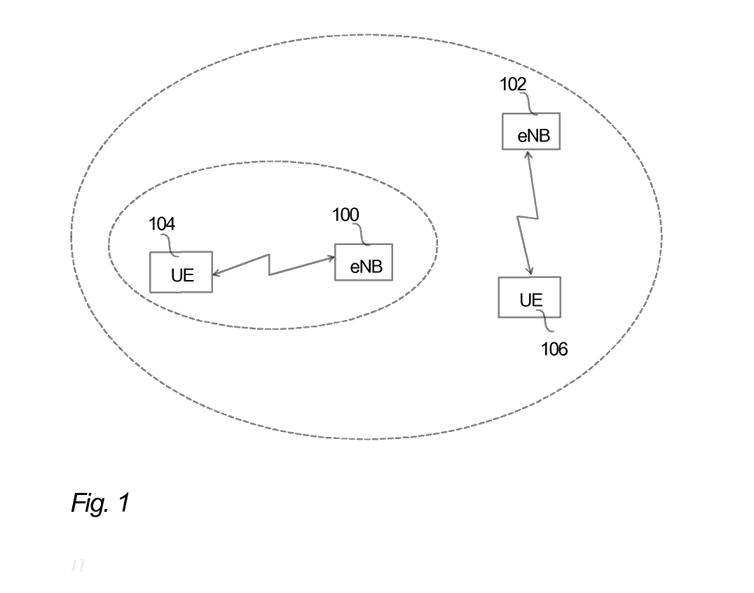

FIG. 1 illustrates a wireless communication scenario to which embodiments of the invention may be applied. Referring to FIG. 1, a cellular communication system may comprise a radio access network comprising base stations disposed to provide radio coverage in a determined geographical area. The base stations may comprise macro cell base stations (eNB) 102 arranged to provide terminal devices (UE) 106 with the radio coverage over a relatively large area spanning even over several square miles, for example. In densely populated hotspots where improved capacity is required, small area cell base stations (eNB) 100 may be deployed to provide terminal devices (UE) 104 with high data rate services. Such small area cell base stations may be called micro cell base stations, pico cell base stations, or femto cell base stations. The small area cell base stations typically have significantly smaller coverage area than the macro base stations 102. The cellular communication system may operate according to specifications of the 3^{rd} generation partnership project (3GPP) long-term evolution (LTE) advanced or its evolution version (such as 5G).

Automatic and accurate network monitoring enables efficient network operation including anomaly detection, problem localization, root cause analysis and traffic/QoS/QoE management actions. Managing the increasing amount of mobile traffic generated by the continuous usage of internet-based applications, and the consumption of OTT content, requires network side data collection mechanisms going beyond already existing ones, as real-time insight to the operation and efficiency of the whole end-to-end is needed. Such mechanisms enable network operators to own the customer experience. Traditional telco-domain KPIs such as the collection of non-real-time call setup success rates or high level aggregated throughput/data volume statistics carry no information about user plane or individual OTT application sessions; thus it is not possible to use them are for QoE insight generation. Advanced mechanisms such as QoS/QoE/bandwidth management/enforcement, congestion detection, congestion control, network operation and troubleshooting, etc. require real-time, accurate and granular information on the status of the network and user plane applications. This information enables decision making and corrective/preventive actions as well.

User plane traffic-related KPIs, if any, are usually measured and collected independently from each other, often intrusively to the original traffic, which makes the measurements non-scalable and usable only for dedicated per-KPI statistical evaluation.

The automatic and efficient monitoring of the network status, the detection of network side problems (e.g. overload, congestion, failures, non-optimal configurations, etc.) and the localization and diagnosis of the anomalies are possible by having a set of well defined, correlated set of KPIs. Various network monitoring solutions are able to separately collect network side QoS KPIs such as RTT, delay, jitter, load, throughput, etc. However, the measurement of these KPIs is neither correlated in time nor based on the same end-to-end context (e.g. TCP connection). Additionally, their resolution is constrained already during the measurement itself or limited later before the measurements are collected and interpreted, that is, when aggregating over a QCI class/cell/eNB, or as the measurement time window is typically in the order of minutes or even more. Aggregation not only reduces the resolution and prevents real-time use cases, but also means loss of information and detail. Timely delivery of the collected KPIs and their real-time evaluation is also an issue, i.e. measurements of different KPIs may be collected and processed asynchronously. Due to the asynchronous measurement, coarse aggregation granularity, long measurement window, the lack of timely delivery and unsynchronized collection and processing, relevant information is lost, and it is not possible to use the measurements for context based analysis (e.g. identify patterns, causal effects, correlated KPI values or changes, such as increased delay and loss and decreased throughput at the same time). Even if the distribution of the KPIs is measured and is available separately, it only enables their individual (per-KPI) statistical evaluation, but the correlation between the KPIs (e.g. if the two KPIs reach their peaks at the same time, whether they are moving in the same or opposite direction, etc.) is still permanently lost. This kind of information is relevant in case enhanced anomaly detection and diagnosis methods are to be applied. Another issue with the long (in this context a 1 second time window is already long) measurement window and aggregation is that measurements are updated too slowly, and temporary peaks are averaged out, making it impossible to detect real-time changes in a dynamic system. Therefore, these measurements may only be used for coarse long term statistical network monitoring, but not for real-time detection and decision making that enables efficient network management and operation.

Only few measurements in existing network monitoring systems are related to QoE. Some values or scores may enable relative comparison of application sessions (e.g. higher score means less stalling in the video), but these are not based on QoE surveys and thus do not reflect or quantize the opinion of the end users (instead, they are simply an aggregated numerical representation of QoS measurements via arbitrary formulas).

In LTE, no congestion detection mechanism is provided on S1 and X2 interfaces; thus there are no built-in transport network related measurements in the native LTE protocol stack, for providing information on the network status.

A one-way active measurement protocol (OWAMP) defines a standardized framework for one way delay measurements. The mechanism is based on scheduling test sessions between two network nodes, referred to as the sender and the receiver. OWAMP assumes that the clock of the participants is synchronized (e.g. via GPS). During a test session, a sender transmits a series of UDP test packets, each carrying a timestamp corresponding to its transmission at the sender side. The receiver reads and decodes the timestamp from each test datagram and compares it to its local clock to compute a one way delay between the server and itself. The result of the measurements may be collected and analysed later. A two way active measurement protocol (TWAMP) is a framework for measuring round-trip (i.e. two-way) delays. OWAMP and TWAMP both require the injection of additional test traffic into the network, and the measurements are taken on this separate test traffic. Therefore, the collected measurements only reflect the conditions experienced by the test traffic and not that of the real user plane traffic, which may be different. The test traffic itself (being close to a constant bit rate non-TCP traffic) also responds differently to the network conditions compared to the (mostly TCP based or TCP friendly) real flows. Therefore, the relevance of the insight obtained from separate test traffic is lower compared to measurements obtained on original packets. The OWAMP/TWAMP mechanisms are also not well scalable, as in order to obtain the one/two way delay measurements on multiple network segments, it is required to establish multiple peer-to-peer test sessions, one per each network segment. This increases OWAMP/TWAMP management complexity and control traffic overhead (to negotiate the test sessions) and may also increase the amount of injected test traffic (as one network segment may be covered by multiple test sessions). Additionally, in order to obtain measurements corresponding to multiple PHBs, separate per-PHB (per-DSCP) sessions need to be manually configured. This approach is not usable in a dynamically changing scenario.

In HSDPA and HSUPA, a standardized congestion detection and congestion control mechanism exists on the Iub/Iur interfaces that is based on detecting delay build up and packet loss within the frame protocol (FP) layer. Since the measurements that enable the congestion detection are explicitly encoded into FP headers, they may not be extended to provide end-to-end delay/loss measurements or additional KPIs and are limited to the Iub/Iur interfaces. Additionally, that approach is based on static thresholds, which are not able to accurately detect congestion in certain network conditions and traffic mix scenarios.

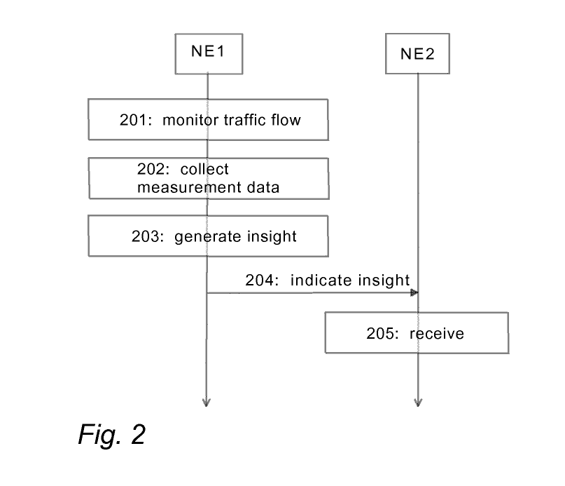

Let us now describe an embodiment of the invention for traffic flow monitoring with reference to FIG. 2. FIG. 2 illustrates a signalling diagram illustrating a method for communicating network service parameters between network elements of the cellular communication system. The network element may be a network node, an access node, a base station, a terminal device, a server computer or a host computer. For example, the server computer or the host computer may generate a virtual network through which the host computer communicates with the terminal device. In general, virtual networking may involve a process of combining hardware and software network resources and network functionality into a single, software-based administrative entity, a virtual network. In another embodiment, the network node may be a terminal device. Network virtualization may involve platform virtualization, often combined with resource virtualization. Network virtualization may be categorized as external virtual networking which combines many networks, or parts of networks, into the server computer or the host computer. External network virtualization is targeted to optimized network sharing. Another category is internal virtual networking which provides network-like functionality to the software containers on a single system. Virtual networking may also be used for testing the terminal device.

Referring to FIG. 2, in item 201, a network node NE1 monitors a user plane traffic flow transmitted in the network, in order to perform measurements on selected data packets. Based on the monitoring, the network node collects 202, in a correlated way, one or more of: user measurement data, application measurement data, quality of experience measurement data, network side quality of service measurement data and a set of key performance indicators. Correlated collecting means that in one measurement round (that is, using the same packet or a packet and the corresponding response packet) the network node NE1 is able to qualify QoE, QoS and the network status at the same time, so that the collected QoE, QoS and network status insights each correspond to a given user's application at the current network condition. Based on the correlated collecting, the network node generates 203 real-time correlated insight to customer experience. Based on the correlated collecting, the network node may also determine 203 a network side reason for possible degradation in quality of experience.

In item 204, the network node may indicate the generated correlated insight and/or the determined reason for the QoE degradation to another network node NE2. Alternatively, the network node may indicate the generated correlated insight and/or the determined reason for the QoE degradation to a network operator. In item 205, said another network node may receive the generated correlated insight and/or the determined reason for the QoE degradation respectively.

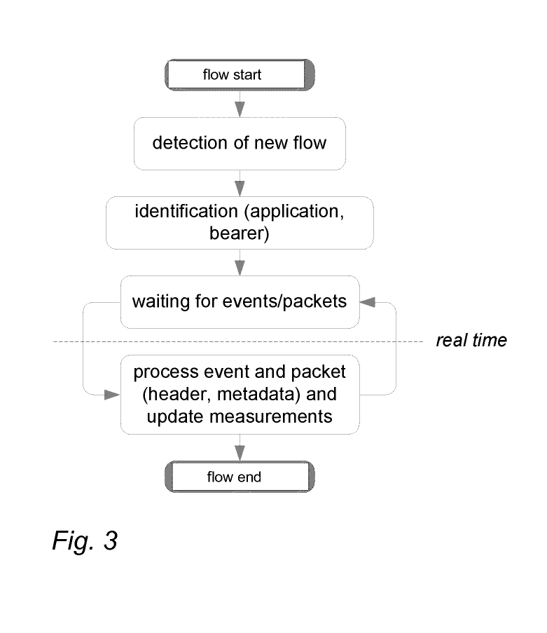

An embodiment enables providing real-time correlated insight to the user behaviour, to the attributes of the application sessions, and to QoE of the applications and the status of the network, through the collection of relevant user, application, QoE and network side QoS measurements and KPIs. The terms user measurement data, application measurement data, quality of experience measurement data, network side quality of service measurement data and/or the set of key performance indicators as used herein may refer to any relevant user-related, application/service-related and/or network-related measurement data and/or performance indicators respectively. In an embodiment, the relevant measurements data are collected in real-time from the user plane traffic through continuous packet monitoring. The establishment of each user plane flow is detected and associated with a given user and application. For each user plane flow, there is a set of KPIs updated continuously whenever a relevant event (e.g. arriving packet, such as a data segment or acknowledgment, retransmission, discard, out-of-order segment, etc.) is detected or a new piece of data is transferred through a connection in any direction (see FIG. 3 illustrating flow based monitoring and measurements). True real-time measurements and insight generation are enabled as the instant KPI values are derived and updated immediately upon the detection of each relevant event. KPIs generated in this way directly reflect the packet level end-to-end performance for each flow and thus enable efficiently capturing information on the application performance including the transient degradations/improvements. The relevant measurements data may be collected from TCP (which is a transport layer protocol used by many applications to send or download data) and/or UDP traffic (e.g. streaming over RTP/RTSP, etc.). The measurements may be performed both on plaintext and encrypted (e.g. HTTPS, TLS, VPN, etc.) flows.

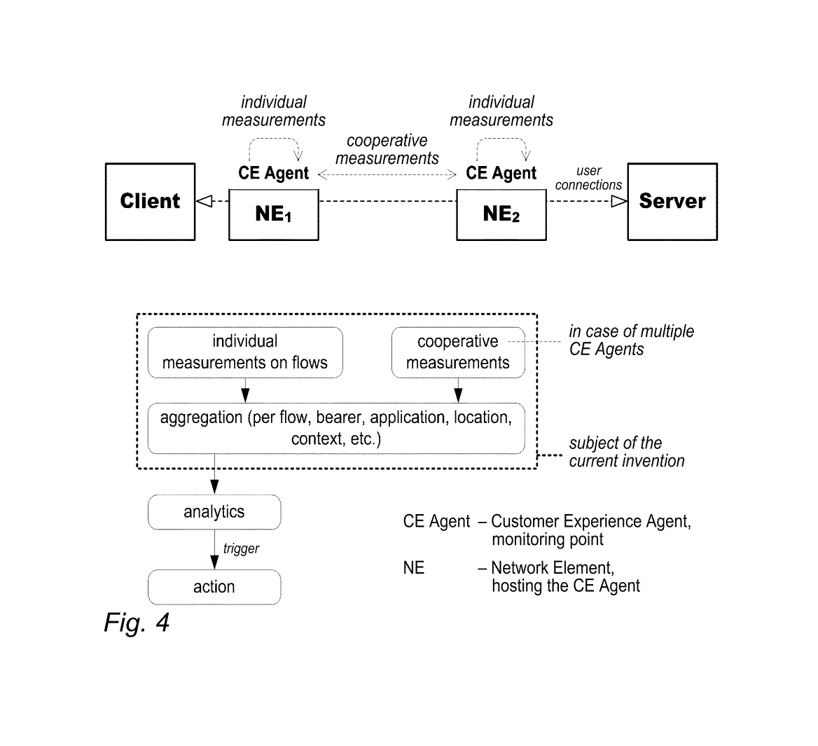

In an embodiment, the measurements data may be collected either by a single measurement point or by multiple measurement points placed at relevant locations along the end-to-end path of the user plane traffic through the mobile network. In case multiple measurement points are used, they are cooperating (i.e. exchanging specific status or measurement information) in order to enhance the accuracy and/or the level of detail of the insight to the network and application performance with specific information accessible only from their location, see FIG. 4 illustrating the obtaining and aggregating of individual and cooperative flow based measurements. A granular and accurate view is delivered on the user actions, the application parameters and QoE, which is not derivable from existing KPIs such as UL/DL data volume per application or high level throughput measurements. The QoS measurements data are collected on individual flow level and aggregated to any possible level, e.g. application (in case the application transfers data through multiple simultaneous flows), bearer, cell, QCI, eNB, DSCP, S1, etc. The collected measurements data represent a superset of existing legacy QoS measurements, therefore they enable the existing QoS measurement-based use cases as well (e.g. delay/load threshold based detection, triggers or actions).

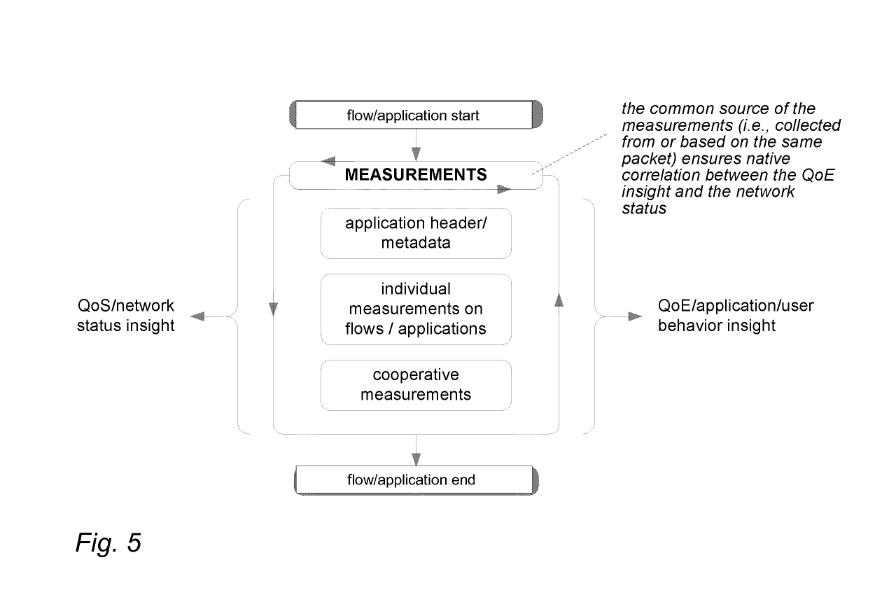

In an embodiment, the monitoring points follow the same data segment and the corresponding acknowledgement packet in case of TCP-based applications, or the data frame and the corresponding receiver report in case of RTP/RTCP/RTSP based applications, as they are traversing through the network in end-to-end, and the monitoring points perform (individually or by cooperating) the measurement of each relevant KPI on the exact same packets. This results in the measurement of a coherent set of data per packet (or pair of packets, i.e. data and the corresponding acknowledgement) and a natively correlated set of QoE and QoS KPIs per each application session/flow. FIG. 5 illustrates obtaining of correlated QoE, user behaviour, application and network side QoS insight.

In an embodiment, correlated anomaly, degradation and congestion detection is performed by estimating bottleneck capacity and by considering the application level performance (QoE) when anomaly or congestion is detected and analysed. Accordingly, the capacity of a radio cell or a bottleneck transport link may be measured, the load on links or network elements may be measured, context based profiles of the KPIs may be created, and unusual events and user plane anomalies may be detected in real-time. This capability is superior to the simple delay/loss threshold based congestion detection mechanisms since the simple delay/loss threshold based congestion detection mechanisms are not universal and they are not applicable as a general mechanism, as any static thresholds generate false positives or missed congestion events due to the heterogeneity of the network deployment and dynamicity of the traffic generated by the applications.

In an embodiment, real-time measurements and KPI collection are created instantly based on events/packets detected on the individual flow basis. The measurements are available already at the flow level as well as aggregated up to any meaningful higher level (such as application, user, cell, etc.). The measurements data are collected on the user plane data defining the customer experience (instead of on artificially injected test traffic).

In an embodiment, correlated measurement/collection is performed on user, application, QoE and network side QoS KPIs.

In an embodiment, profiling and anomaly detection are applied to the application level user plane packet flow (i.e. high frequency individual events) in real-time (instead of highly aggregated time series of KPIs off-line). The user plane anomalies may thus be detected much earlier. Information may be provided for enriched network monitoring, troubleshooting, customer care and/or marketing campaigns.

In an embodiment, the detected anomalies are analysed in order to identify the degradations due to e.g. congestion. Congestion characterization, bottleneck classification and detecting/measuring the amount of available resources in the system may be carried out.

An embodiment is applicable to multi-vendor environments and any radio access technology (including but not limited to 3G, LTE, 5G and Wi-Fi), as the measurements are collected in the user plane by observing the traffic and packets generated by active applications. An embodiment may be applied at the Iub/Iur interface where the measurements are collected from 3G specific user plane protocol layers at RNC.

In an embodiment, measurements are performed on both TCP and non-TCP flows (e.g. UDP streaming). This generates an insight into any possible application (and enabling quick adoption of any new application to appear in the future).

An embodiment is applicable to the control plane in order to both quantify/qualify the control plane performance and to increase the accuracy of the QoE measurements.

In an embodiment, a real-time correlated insight is generated into the user behaviour, the attributes of the application sessions, QoE and the status of the network, through the collection of relevant user, application, QoE and network side QoS measurements and KPIs. In one measurement round it is possible to qualify QoE, QoS and the network status, thus providing not only an insight to the customer experience, but indicating the network side reason for possible degradation.

In an embodiment, congestion detection is performed based on the correlation of measured QoE degradation, and network state detection is performed based on advanced indicators such as loss pattern detection, delay profile analysis and correlated delay/loss/throughput profiling and classification. The mechanism is automatic and self-learning requiring no parameterization and being able to (self-)profile a given end-to-end instance (such as an S1, X2, Iub or Iur interface), that is, to adapt itself to a given instance, learn the behaviour typical to that instance and detect any deviation from that one. The mechanism is able to adapt itself to the actual conditions, which is a major step towards cognitive networks.

In an embodiment, congestion characterization and bottleneck classification is based on profiling and pattern matching techniques and by monitoring and analysing enhanced indicators such as discard pattern or delay distribution attributes.

In an embodiment, control plane performance is monitored in correlation with the user plane application QoE to provide a holistic QoE insight covering the entire lifetime of the user connections including control plane procedures such as attaching to the network.

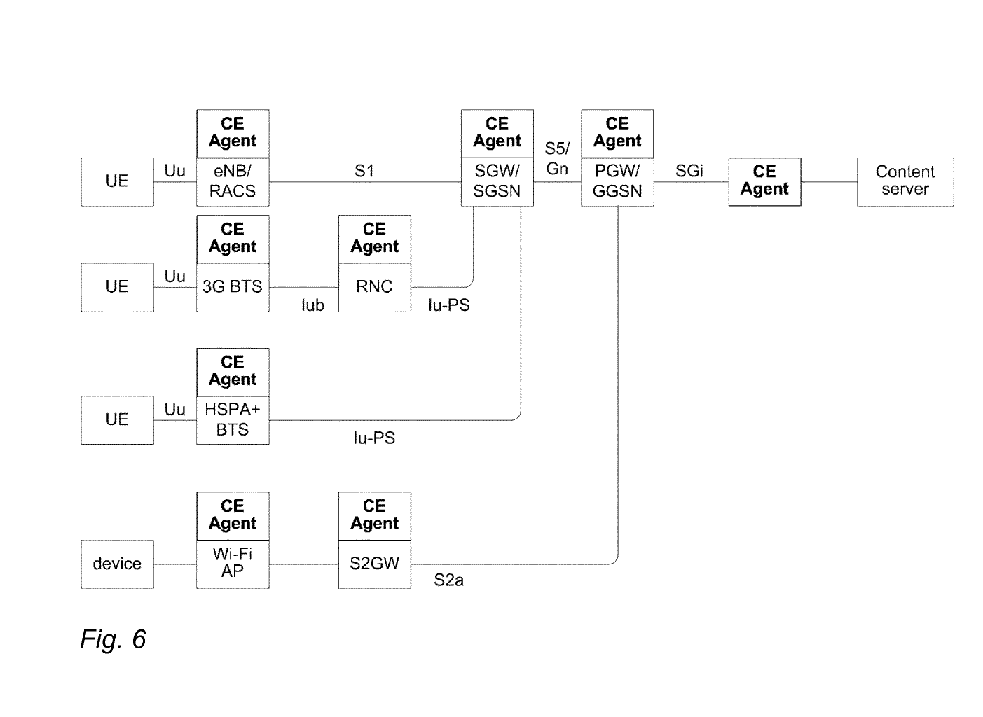

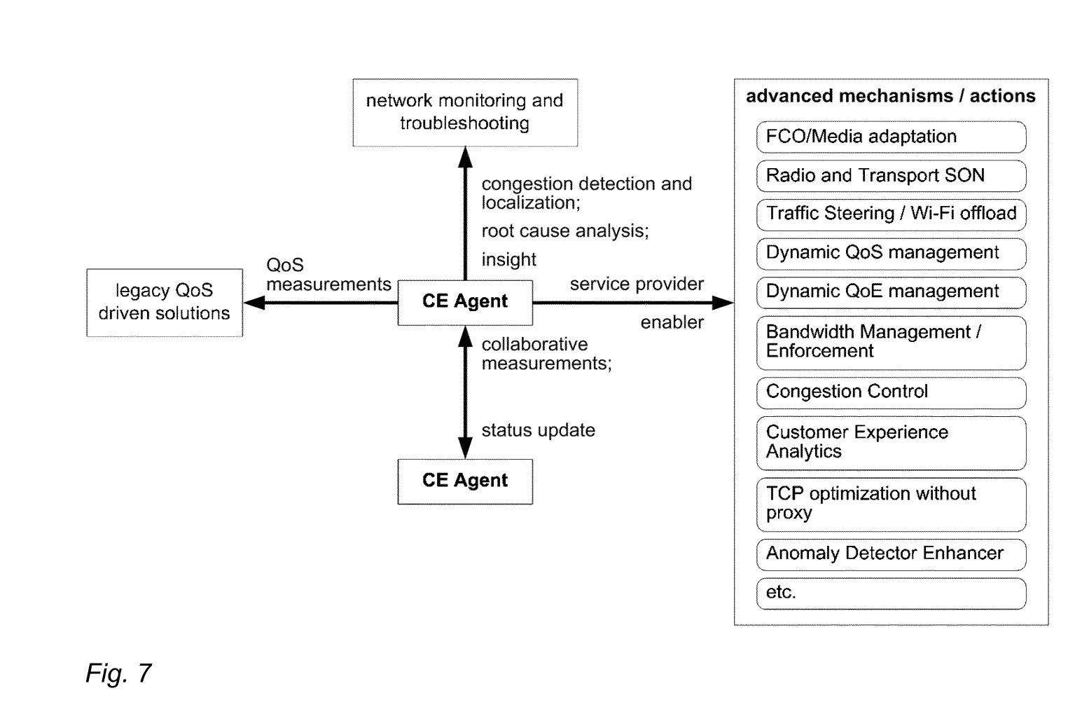

In an embodiment, a customer experience (CE) agent is running on or attached to a network element where it has access to the user plane packets. FIG. 6 illustrates deployment options for the CE agent. The CE agent may be deployed and operated on top of any network technology at every location where access to the original traffic generated by UEs is possible. This enables a true multi-vendor solution supporting heterogeneous network deployments as well. Measurements data are collected on the user plane traffic itself which enables deployment in any new technology such as 5G. For example, supposing a standalone box on in the core, running in SGW/PGW, in eNB/RACS or in HSPA+BTS, the CE agent acts as a middle box that intercepts the packets sent by the communicating end devices (referred to as a client/UE and the server on the general level) to perform the required user, application, QoE and QoS measurements. The measurements are executed by monitoring the header content of the data packets, recording the time when the packets were intercepted and by adding/removing additional header fields through a mechanism referred to as header enrichment. The header enrichment, i.e. adding and removing additional header fields, is done only if multiple CE agents are deployed in the end-to-end path of the user plane flows with the scope to convey specific information between the CE agents. This is an enabler of collecting dedicated measurements per network segments and of the problem localisation in case of a detected degradation. Use cases for the CE agent and the inter-CE agent interactions are illustrated in FIG. 7.

In another embodiment, when running in the two end points of the Iub/Iur interface (3G BTS and in the RNC) where access to the user plane packets generated by the communicating entities is not possible, the CE agent collects the relevant information by monitoring the content of the Iub/Iur protocol headers. Accordingly, monitoring on the Iub/Iur frame protocol frames is used for loss and delay measurements on these interfaces, to collect explicit indication of congestion on the transport network (i.e. CI sent by RNC to BTS, RLC status PDUs, etc.), to monitor the operation of the HSPA congestion and flow control by observing and profiling the content of the HSPA FP control frames (Type I/Type II). Additionally, the CE agent attached to RNC collects insight from RRC used for anomaly detection and localization, such as explicit indication of radio interface or coverage problems.

The QoS and QoE measurements may be executed simultaneously per each user plane flow, by extracting/monitoring the content of the protocol headers, application metadata and by detecting the user actions and behaviour. The QoS measurements include a set of KPIs that are the accurate indicators of the level of service experienced by the users and on the same time of the network status as well such as increased load in the system (e.g. throughput, delay, RTT, packet loss ratio, packet discard patterns, etc.). Accordingly, the QoS measurements have two categories: individual measurements that may be executed by each CE agent independently, and collaborative measurements that may only be obtained by active collaboration between the CE agents. The collaboration makes use of the two-directional packet transfer of TCP, i.e. due to its acknowledging method packets are transmitted in both UL and DL in each flow even if data is transferred only in DL or UL. Non-TCP flows may also have similar mechanisms (e.g. feedback from UE in UL in additional to regular data flow in DL) that enable to convey information via header enrichment in both directions. In each case the measurements are collected per each flow then aggregated in meaningful ways to serve the creation of the KPIs describing the network quality and status, to enable efficient congestion and anomaly detection and analysis, and finally to identify the outliers.

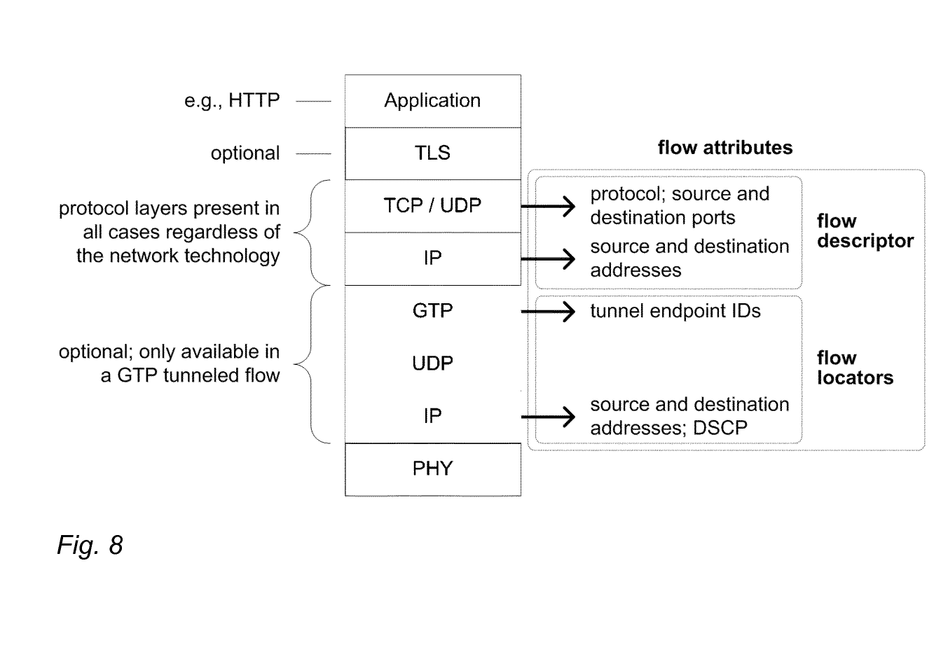

In an embodiment, advanced monitoring and measurements are carried out for user plane insight generation and calculation of a wide range of QoS and QoE KPIs. The CE agent intercepts each traversing packet in order to detect the establishment of new TCP connections (identified by a SYN flag set in the TCP header) and to detect the establishment and presence of non-TCP flows (e.g. UDP streaming) as well. For each flow, the CE agent identifies and maintains a set of attributes, detected from the intercepted packet headers. The attributes include e.g. an application layer tuple (protocol, IP addresses and TCP/UDP ports), referred to as a flow descriptor (see FIG. 8 illustrating the flow descriptor and attributes parsed from the application layer packet headers). Additionally, in case the flow is encapsulated in a GTP tunnel at the location of the CE agent (e.g. S1/X2 interface or in RACS), the outer IP addresses, the GTP tunnel endpoint identifiers in the UL and DL directions and a DSCP class of the outer IP header in DL and UL, referred to as the flow locator, also become part of the flow attributes. The CE agent is able to monitor any additional header field in the protocol layers as well, in order to perform the measurements (e.g. using the TCP sequence/ACK numbers, TCP advertised window, etc.), or to enable the aggregation of the measurements along various dimensions (e.g. using the IP DSCP field to provide per-PHB aggregations). During the lifetime of a flow, attributes that are not part of the flow descriptor (such as DSCP) may change (e.g. due to real-time bearer QoS update). The CE agent detects these changes and updates the attributes of the corresponding flow in real-time, as soon as the first packet with the changed attribute is intercepted.

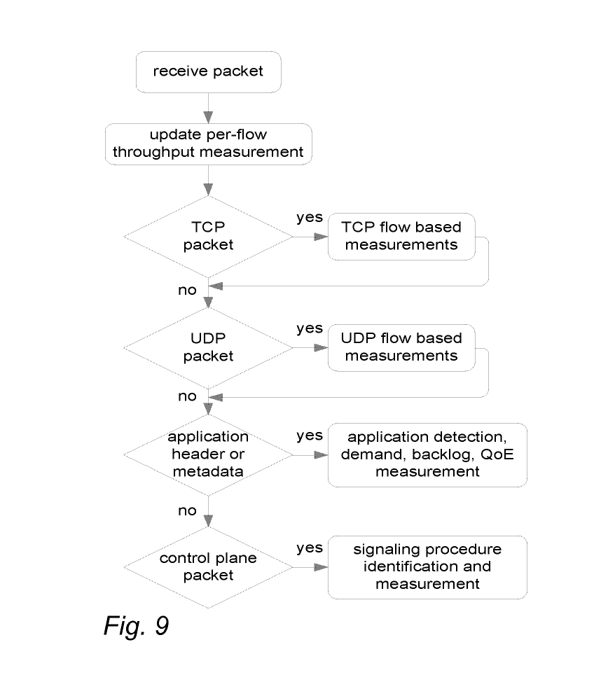

After a flow is detected, the CE agent continuously performs QoE monitoring and network side QoS measurements on the packets of the flow. The QoS measurements data obtained by monitoring a given flow are collected in a per-flow data structure, indexed with the flow descriptor of the flow. Each packet intercepted by the CE agent is analysed, and based on the existing protocol headers feasible QoE and QoS measurements are executed (see FIG. 9 illustrating per packet monitoring actions).

The QoS measurements may be categorised in two categories: 1) individual measurements that are obtained by each CE agent without synchronization with other CE agents; the individual QoS measurements include (but are not limited to) the throughput (collected separately in the UL and DL directions) RTT, the delay/RTT jitter and the packet loss (collected separately in the end-to-end, upstream and downstream contexts); and 2) collaborative measurements that are obtained through status updates between related CE agents using protocol header enrichment; the status updates enable a finer segmentation of the end-to-end QoS measurements with the granularity of the network segments defined by the CE agents; additionally, the protocol header enrichment enables to measure the separate uplink and downlink one way delay between each CE agent in addition to the per network segment RTTs.

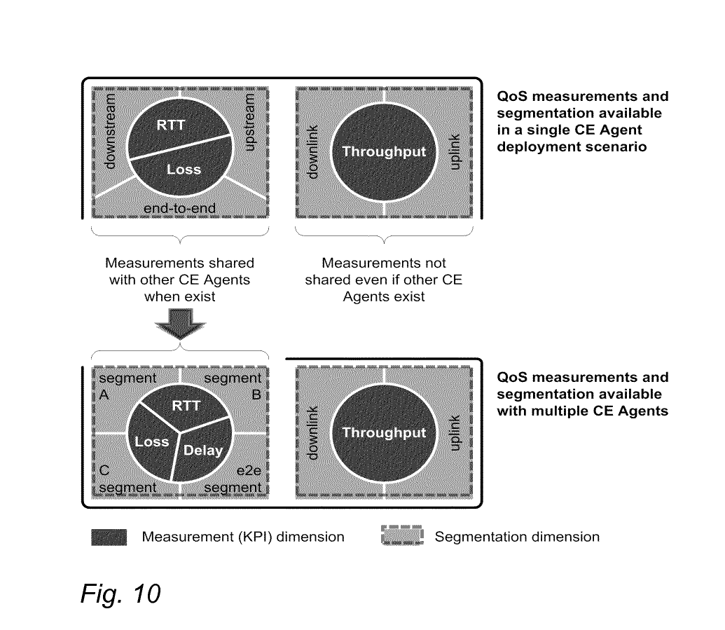

Throughput and load measurements (per flow, application, bearer, DSCP class, cell, eNB, etc.) also enable congestion detection and the measurement of the resources available in the network. Therefore, accurate throughput measurement, as well as its correlation with other indications (such as increased RTT/delay) that enable the detection of high load, may be performed. Individual and collaborative per-flow QoS measurements are illustrated in FIG. 10.

The per-flow QoS measurements may be aggregated along multiple dimensions of the flow attributes, such as generating the aggregation corresponding to a given bearer (identified by the outer IP address and GTP tunnel ID on the S1 interface), UE (flow descriptor UE address on each interface), eNB (outer IP eNB address on the S1 interface), etc. Aggregation along any additional attribute not part of the flow descriptor (such as location) may also be carried out. Multiple aggregation dimensions are also possible, such as creating the per-DSCP aggregates within each eNB. The aggregation is performed by generating the per network segment union or sum of the measurements of each flow that satisfies the aggregation criteria. In order to avoid collecting too many samples in a high level aggregate, samples may be discarded during the aggregation process to reduce the sample size.

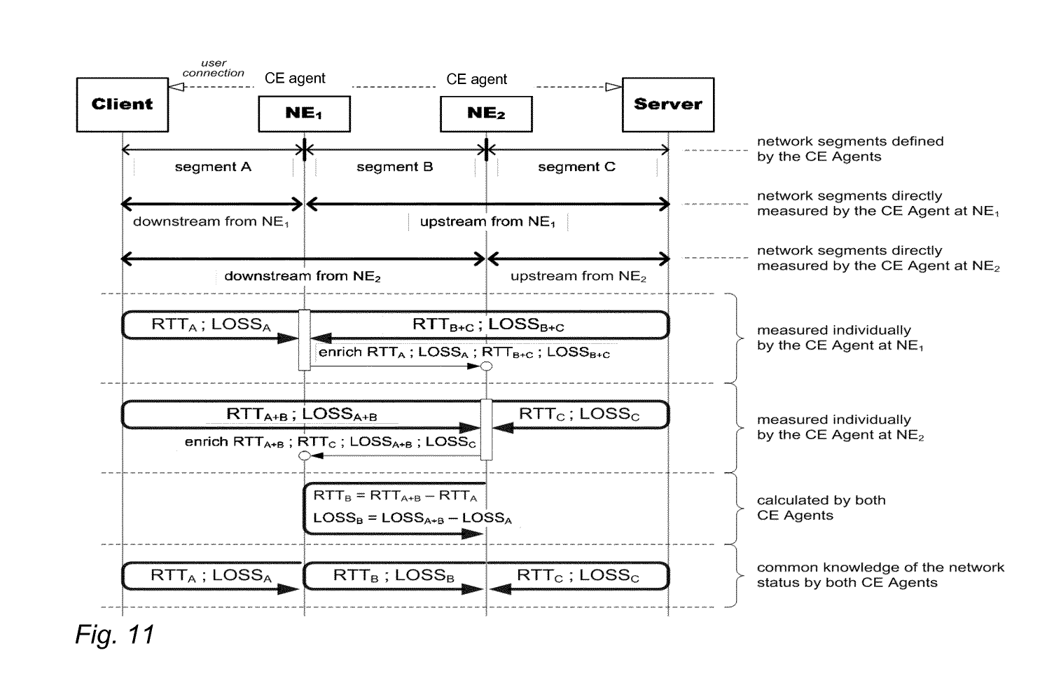

FIG. 11 illustrates collaborative measurements and real-time status updates between the CE agents. The implementation of the collaborative measurements and status update is illustrated in FIG. 11 by means of RTT and loss measurements for TCP flows (however, the principle is the same for any other KPI and flow non-TCP flows having feedback as well). Each CE agent has an identifier (e.g. an integer) that uniquely identifies and locates the CE agent within the network. Each CE agent collects the QoS measurements data separately to its upstream and downstream network segments. Whenever a measurement is taken, the CE agent enriches a measurement tuple to the next UL and DL packet that it receives in the same flow. The measurement tuple comprises the CE agent's own identity, the type of the measurement (e.g. downstream RTT) and the value of the measurement (e.g. 42 ms). The UL packets convey the information to the CE agents located in the upstream direction, whereas DL packets convey information in the downstream direction. When the CE agent intercepts a packet with a header enriched by another CE agent, it decodes the information and combines the received data with its individual measurements data as well as the measurements received from other related CE agents to create per network segment QoS KPIs. Since the measurement tuples are carried in-band in the user plane connections on which they were obtained, the decoding CE agent has the full context required to combine the received measurement with its own upstream and downstream measurements. The status updates ensure that the measurements data obtained by each CE agent are distributed to each CE agent intercepting the same user plane connections so that each related CE agent sharing the same end-to-end context maintain a common knowledge of the network status. The principle may be generalized to an arbitrary number of related CE agents.

The CE agents measure the throughput of the connections individually, based on the amount of data sent in DL or UL in consecutive time windows with configurable window size (e.g. 200 ms). The throughput measurements made by the CE agent do not need to be conveyed to other CE agents since they intercept the same packets and are able to obtain the same throughput measurements data automatically. In case of UDP, the throughput is measured based on the amount of data transferred by the datagrams. In case of TCP, the throughput may be measured both based on the arrival of the data segments and the arrival of the ACK segments. Data segments arriving in DL contribute to the DL data throughput. ACKs received in the opposite UL direction generate the so-called DL virtual throughput which is measured based on the amount of data ACKs incrementally acknowledge corresponding to the previous ACK. The two types of throughputs are complementary: the DL data throughput measures the arrival of data from the upstream (which may include line-speed bursts on the packet level in case there is no upstream bottleneck), whereas the virtual throughput measures the rate at which UE is eventually able to receive the data. The difference between the data and virtual throughputs enables the detection and measurement of a bottleneck that is below the last measurement point in the downstream, e.g. to accurately measure the narrow radio interface capacity by the CE agent that is in eNB or even in the core network. This enables each CE agent to assess the network status solely by individual measurements, without the need to exchange such information with each other via e.g. header enrichment.

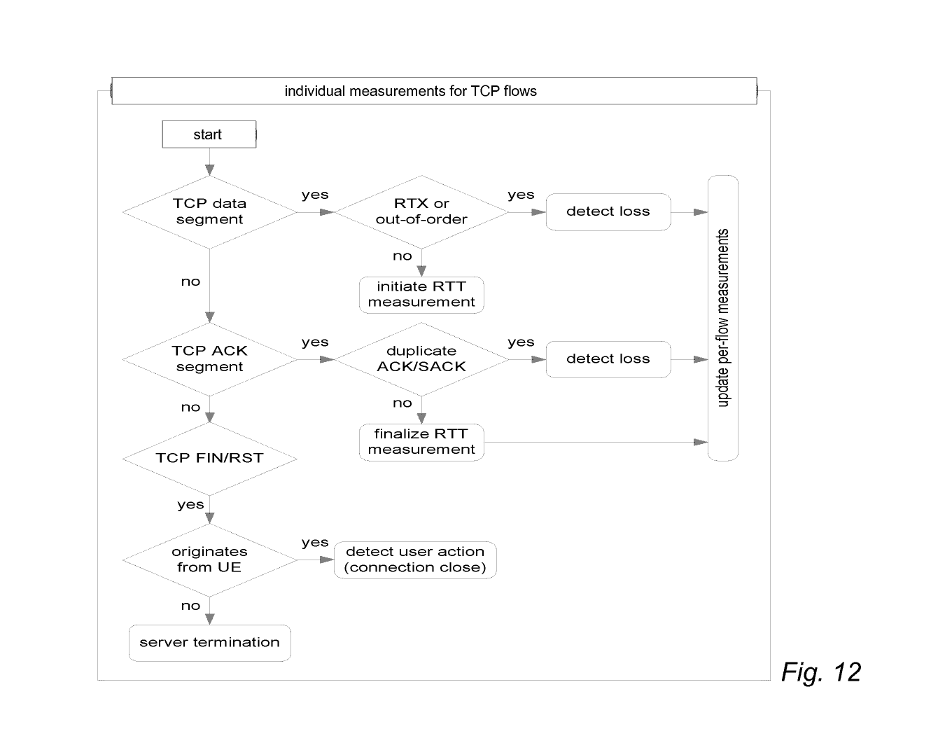

The QoS measurements executed by the CE agents for TCP flows are illustrated in FIG. 12. The CE agents obtain the first RTT measurement in the TCP connections during the handshake, measuring the delay between the initial SYN, SYN+ACK and ACK segments. After the handshake has been completed, the CE agents continue monitoring RTT of the TCP connections by measuring the time between (1) the observation of a TCP data segment with a given sequence number S in the TCP header, and (2) an ACK transmitted in the opposite direction (in the same connection) with an acknowledgement number that is higher than S. This measurement is done for both directions, that is, for each connection, the CE agents maintain an RTT for their downstream segment (measured on connections transmitting data in DL) and for their uplink segments (measured on UL data transmissions). And additional mechanism that the CE agent may use to measure TCP RTT is to measure the time between a duplicate ACK sent by the TCP receiver and the first retransmission originated from the TCP sender. In case of a DL data transmission over TCP, this mechanism may be used to measure UL RTT between the first UL duplicate ACK and the corresponding DL retransmission. In case of an UL data transmission, the mechanism provides DL RTT measurements. In addition to the TCP based RTT measurements, the CE agents measure HTTP level RTT by measuring the time between corresponding HTTP request and response messages. The measurement of RTT is possible in case of any other application or transport layer protocol that has an acknowledgement or request-response mechanism, both on the user plane and on the control plane. Additionally DNS RTT may be measured between the DNS query and response UDP packets (user plane), and RTT may be measured on the SCTP level (HEARTBEAT and HEARTBEAT ACK, control plane) and between corresponding control plane messages such as an attach request and attach accept during radio connectivity establishment.

The CE agents measure loss on the TCP connections by monitoring the sequence and ACK numbers in each connection and detecting both out-of-order segments and duplicate segments. A segment arrives out-of-order at a measurement point if it has a sequence number higher than the next expected in-sequence segment. The expected sequence number may be calculated by summing the sequence number of the last received segment and the size of the segment, both available from the TCP/IP packet headers. An out-of-order segment indicates one or more losses at the upstream network segment. The number of lost bytes is immediately available by calculating the difference between the expected sequence number and that of the received segment, whereas the number of lost segments may be estimated by dividing the lost bytes with the average size of the data segments (which may also be measured and profiled by the CE agent). Since the TCP sender retransmits the lost segments, counting the number of retransmissions that fill the sequence gap gives the exact number of the lost segments. As the retransmission occurs after at least one end-to-end round-trip time (i.e. when the TCP sender notices the loss based on the duplicate ACKs or the SACK option sent by the TCP receiver), the exact upstream loss counting lags behind with one RTT. However, the loss itself may be detected instantly, and the exact number of lost packets is also obtained as soon as it is possible by relying on the TCP mechanisms.

A TCP segment is considered duplicate by the CE agent, if the same segment (with identical sequence number) has already been observed in the given connection, i.e. its retransmission is not necessary from the CE agent's point of view. However, such a retransmission means that there is a loss somewhere in the downstream network segment as otherwise the retransmission had not happened. Therefore, unnecessary retransmissions count as downstream losses. By combining the number of upstream and downstream losses measured individually and reported by the other CE agents through the status update, each CE agent obtains a per network segment uplink and downlink loss ratio. The loss ratio may be expressed both corresponding to packets and to bytes.

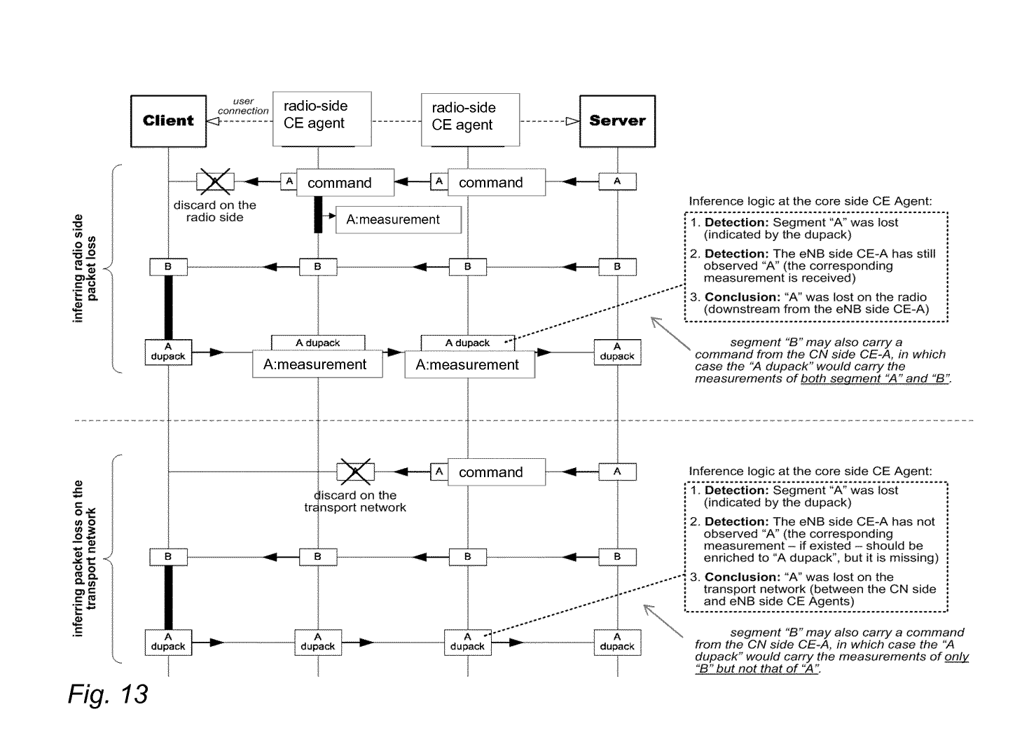

The localization of the packet losses as described above requires each CE agent to individually monitor the TCP segments and ACKs as well as to detect and analyse out-of-order, retransmission and duplicate segments. However, in certain deployments (e.g. the CE agent functionality running in an embedded software environment) the amount of computational resources needed for such complex per-flow sequence/ACK monitoring is not available. Consequently, the radio side CE agent does not perform explicit loss detection, and it is up to the central CE agent to both detect and localize the downstream losses (i.e. differentiate between radio and transport network side losses). However, without explicit loss measurements from the radio side CE agent, the localization of the losses to the radio or transport network is non-trivial. The solution is based on that in such resource limited deployment scenarios, the radio side CE agent does not initiate measurements on its own. Instead, the central CE agent explicitly commands the measurements to be performed by the radio side CE agent. This is done via marking each packet in DL with a command for which the CE agent requires a (non-loss related) measurement to be executed at the radio side. The command provides the required contextual information along with the packets so that the radio side CE agent is instantly able to perform the measurement upon the arrival of the marked packet. The radio side CE agent transfers the result of the measurement in the next UL segment corresponding to the same flow (see FIG. 13 illustrating indirect localization of packet loss at the core side CE agent). The central CE agent is able to detect downstream losses autonomously, wherein the central CE agent is capable of performing localization. Inferring the location of the losses is possible by analysing how the enriched packets carrying the non-loss related measurement results are conveyed to the core. Each time the central CE agent commands the radio side CE agent to perform a measurement on a DL data segment enriched with the command, the result is expected to be received on the UL ACK segment that acknowledges the reception of the DL segment by UE. If the packet with the command (segment “A” in FIG. 13) is received by the radio side CE agent, but then the packet is lost on the radio, the measurement commanded by segment “A” is created and stored at the radio side CE agent, but there is no corresponding ACK in the UL transferred by UE. Therefore, the radio side CE agent needs to wait for a subsequent data segment “B” to be delivered to UE that triggers UL ACK to carry up the pending measurement result. This ACK is a duplicate ACK that indicates the loss of segment “A”. By receiving the measurement result for “A” in the duplicate ACK indicating the loss of the measured segment, the central CE agent is able to infer that segment “A” is still observed by the radio side CE agent (as there is a corresponding measurement), however, the segment does not arrive at UE. This is possible only if segment “A” is lost downstream from the radio side CE agent, i.e. on the radio. In a similar way, the CE agent is able to infer transport network side losses by observing that the segment “A” is lost (duplicate ACK) and the corresponding measurement is not received in the first appropriate UL packet, meaning that the segment “A” does not even reach the radio side CE agent.

The sequence number-based loss detection is an efficient mechanism applicable to TCP connections and other protocols (possibly using UDP) that include sequence numbers (most notably RTP over UDP). Alternatively for loss measurement (for those connections that do not have any built-in sequence number) each packet may be enriched with a per-packet sequence number by the CE agents that first receive the original packet from the server or from the client. Gaps detected in this enriched sequence number immediately and exactly give the number of lost packets.

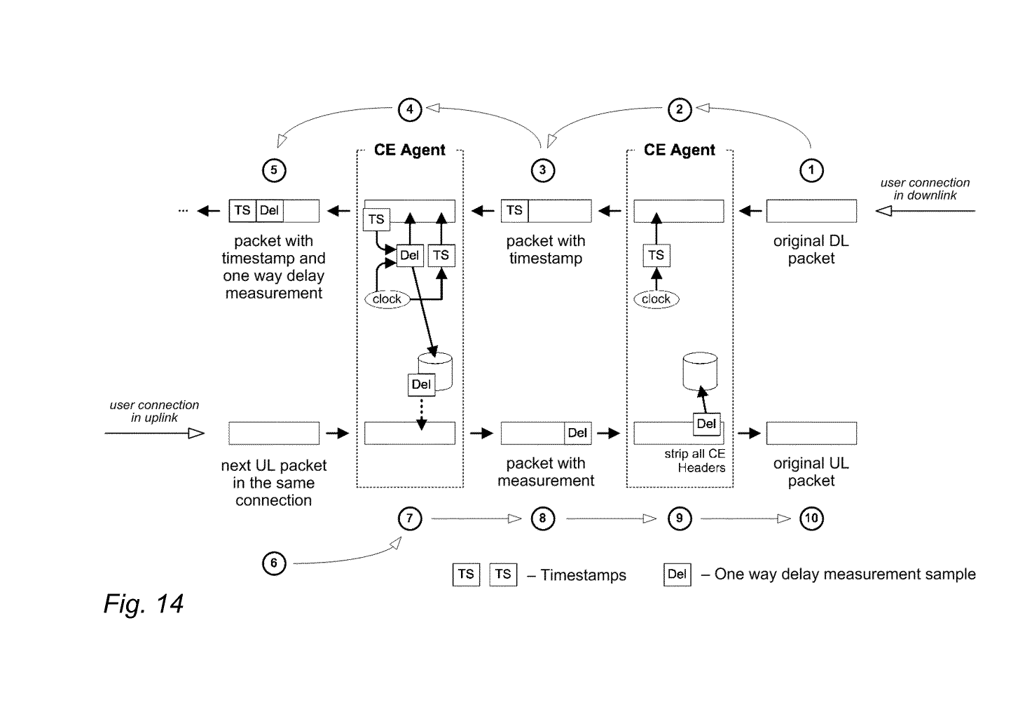

The header enrichment technique is used to measure one way UL and DL delays on each network segment between two CE agents. Obtaining accurate one way delay measurements data requires that the clocks of the CE agents are synchronized, which may be achieved by external mechanisms such as the network time protocol (NTP), the precision time protocol (PTP) or GPS. In order to obtain a one way delay sample, the first CE agent that receives a packet from its source (e.g. the CE agent at the SGi interface in DL and the eNB side CE agent in UL) enriches its current timestamp to the packet header. The next CE agent reads the timestamp and compares it with its own clock to compute the one way delay between the first CE agent and itself. The CE agent swaps the timestamp encoded in the packet by the previous CE agent with its own current timestamp before it forwards the packet to the next segment. When the CE agent obtains a measurement sample, it also enriches the result into the next DL and UL packets that arrive at the same user plane connection that carried the timestamp as part of the real-time status update. The one way delay measurement is illustrated in FIG. 14 in the downlink direction with two CE agents. The collaborative measurement of the one way downlink delay between two CE agents is also applied to measure one way delay in the uplink direction.

The CE agent that is the last one in the packet forwarding direction (e.g. at eNB in downlink or on the SGi interface in the uplink) strips the enriched data from the protocol headers. The stripping ensures that no information leaks out of the network segment, which eliminates the risk of confusing end hosts.

For applications such as RTP/UDP streaming or VoIP/VoLTE (which also use RTP), the RTP level sequence numbers may be used for loss detection (similar to the TCP sequence numbers). The one-way delay measurements as discussed above are also available. Additionally, for the application profiling, the pattern of the packet inter-arrival time and measuring the jitter at various measurement points provides an indication of their quality. Degradation is detected by measuring and profiling unstable and fluctuating patterns. The degradation may be localized by exchanging the detected patterns among the CE agents and finding the network segment bound by two CE agents where the first one (in the direction of the packet transmission) still measures a stable pattern, whereas the next CE agent already detected a fluctuating pattern. Additional information on the quality of the connection may be extracted from the receiver reports (RR) sent by UE. As in case of VoLTE, both UEs engaged in the conversation send RRs, the quality of both call legs are monitored in this way.

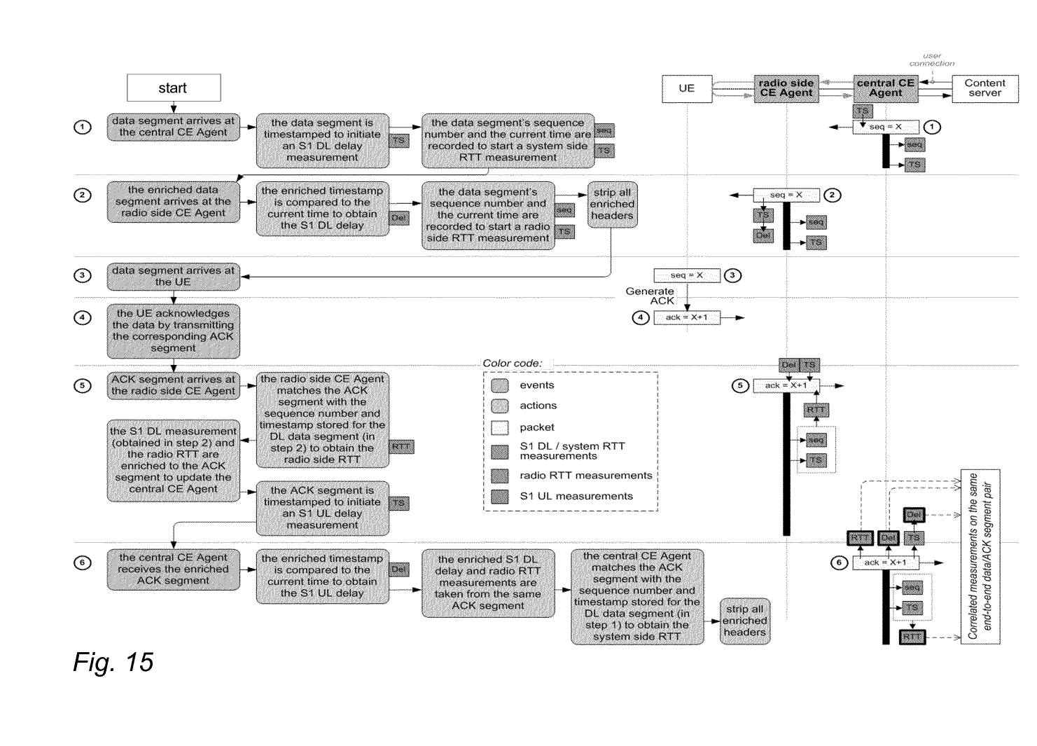

The collaborative measurements and real-time synchronization of the CE agents yield natively correlated KPIs, as the same user plane packet or corresponding request/response or data/ACK packet pairs are used to measure multiple KPIs and at the same time also to distribute the measured KPIs within the same end-to-end round-trip. This enables the CE agents to update the per-flow measurements within one RTT, as shown in FIG. 15 illustrating one-RTT correlated measurement of multiple KPIs.

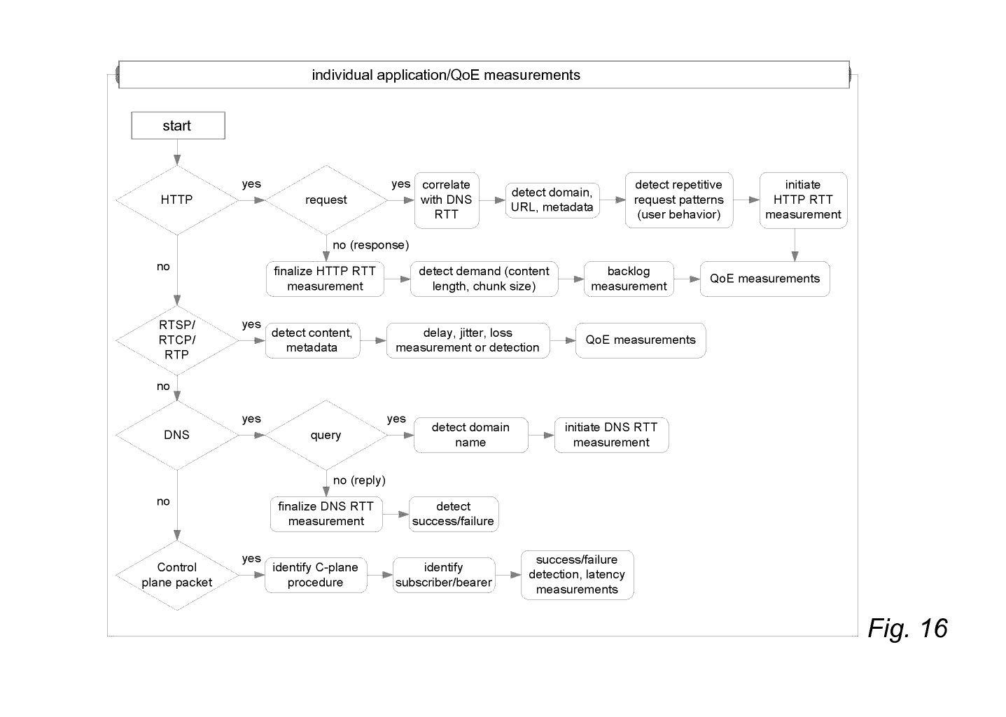

The QoE measurements are executed simultaneously per each user plane flow, by extracting/monitoring the content of the protocol headers and application metadata (TCP, IP, UDP, RTP, RTCP, RSTP, HTTP, etc.) and by detecting the user actions and behaviour (see FIG. 16 illustrating application specific QoE measurements). The latter is done by detecting flow, session or application termination, user request initiation or reaction time, separation of user initiated requests from automated/script generated events, detection of frustrated usage patterns, etc. The application metadata includes application or session specific information such as the resolution, codec, format or encoding rate of a video/audio stream, the size and domain of a web page, the type, structure or importance of the content, etc. The QoE measurements include application-specific dedicated KPIs and measurements that are accurate indicators of the customer experience (e.g. web page download time, video time to play and stalling, etc.).

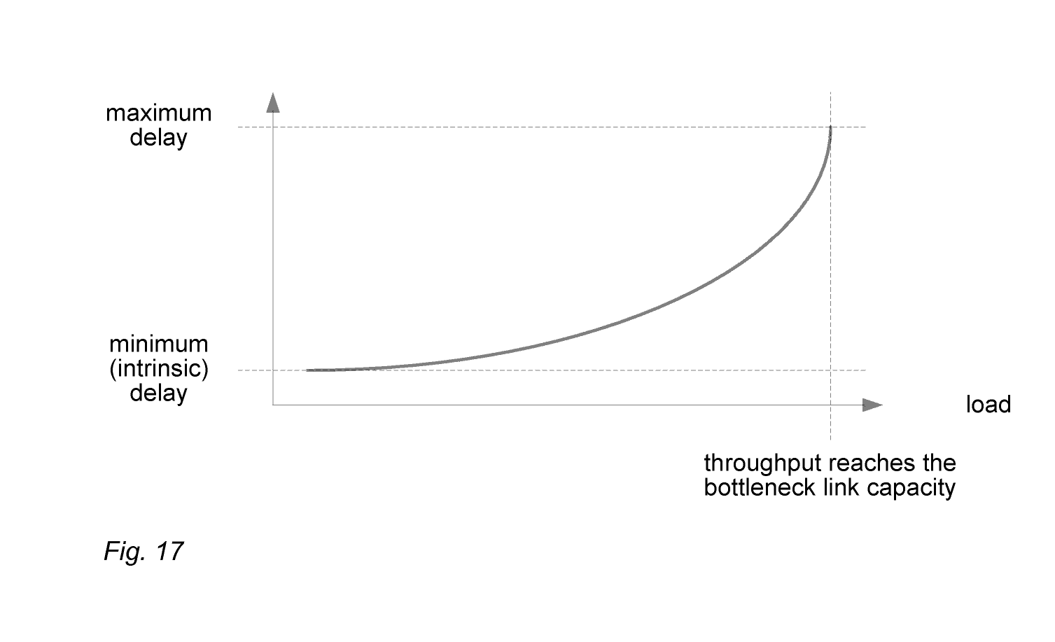

In an embodiment, real-time congestion detection, localization and bottleneck classification is carried out. Since the CE agents sharing the same end-to-end path have the same QoE insight and a common knowledge of the per network segment KPIs, each CE agent is able to detect congestion and localize it with the granularity of the defined network segments. Congestion is detected based on the increase RTT/delay and packet loss. In order to put the measurements into context, the CE agent profiles the delay and loss as the function of the load on each network segment. If a network segment is only lightly loaded, no significant packet buffering happens and the measured delay on the network segment is the intrinsic delay of the system (i.e. the sum of the physical propagation delay and the latency added by the processing and internal forwarding within the network elements, transport devices, etc.). As the load increases and the network segment has a bottleneck link within the end-to-end path, the packet buffer before the bottleneck link starts to accumulate packets, and the delay measured on the network segment increases due to the queuing delay added by the bottleneck buffer. The maximum delay is measured in case the buffer is full, corresponding to the maximum queuing delay. In case the buffer does not deplete, the measured throughput is steady and equal to the capacity of the bottleneck link. By profiling the delay on each network segment, the CE agent is able to put the measurements in context and detect, if the increased delay on a network segment is due to increased load and thus the network segment is congested. FIG. 17 illustrates a delay profile on a network segment.

The CE agent also monitors the packet discards and their pattern for congestion detection. Sporadic losses (i.e. single random discards with no correlation between the discards) and bursty discards (i.e. discarding multiple consecutive packets) indicate different cases. The sporadic discards (especially on a transport network segment) indicate the usage of advanced queue management (AQM) mechanisms (such as RED or CoDel) which execute random early discards in case the buffer load or the queuing delay increases but the buffer still has free space to hold additional incoming packets. This indicates a segment where the system resources are highly utilized, however, there is no congestion yet and the system is efficiently used. Bursty discards resulting from buffer overflow are, on the other hand, an indication of congestion. By examining the intensity of the discards and the discard pattern, the CE agent detects if the network segment is in an early stage of overload (sporadic losses) or in congestion (tail drops).

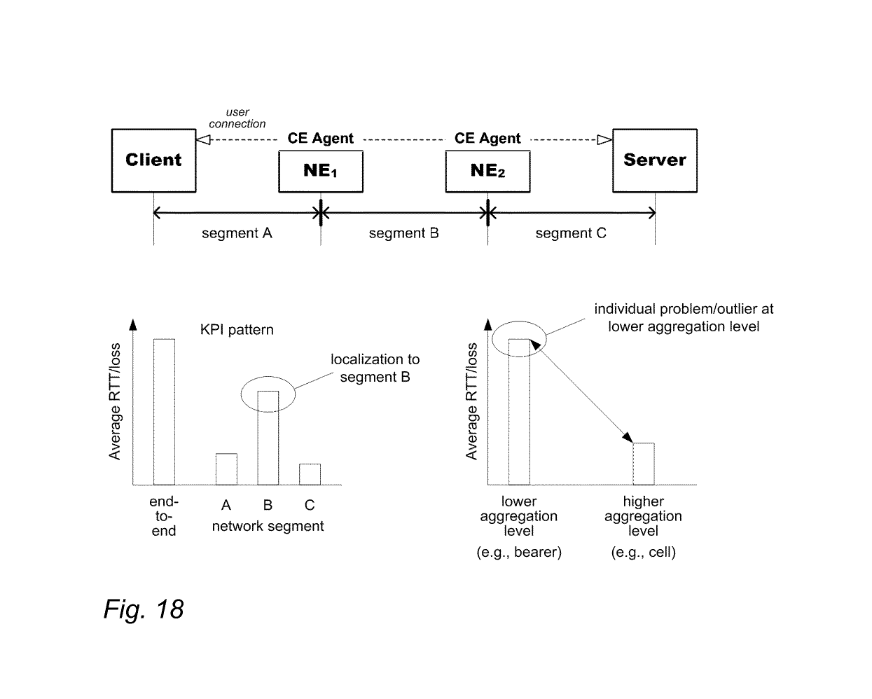

Besides per-network segment profiling and analysis, the congestion is also localized by comparing the current per segment RTT/delay and loss measurements with the end-to-end RTT and loss measurements. In case the majority of the end-to-end RTT/delay and loss are contributed by the same network segment, the congestion is localized to the dominant segment (see FIG. 18 illustrating congestion localization and outlier detection). The pattern of the KPIs (i.e. which segment is dominating compared to the others and to the end-to-end) directly defines the location of the congestion. A similar mechanism may be used to detect outliers, by comparing the measurements and KPI patterns of a given aggregation level (e.g. a single bearer) to the measurements of a higher aggregation level (e.g. the cell or eNB level measurements). In case there is a congestion pattern in the lower aggregation level (e.g. on the radio) whereas there is no such pattern in the higher aggregation level, the lower aggregation level is an outlier likely due to individual problems. This is usable to detect individual poor individual channel quality for a given UE in case its bearer/UE level radio side RTT/loss measurements are outstanding compared to the cell level measurements. Applying this to the transport network measurements, the build-up of congestion may be detected on specific DSCP code points (in case of differentiated services IP QoS architecture) or p-bits (in case of Ethernet IEEE 802.1p QoS architecture). The congestion patterns usually start to show at the aggregation levels representing lower priority traffic as the corresponding packets are the first to experience prolonged queuing delay or discards.

The detection of the congestion is real-time, and it happens instantaneously as soon as the delay/loss measurements indicate a problem. Since the CE agent uses protocol header enrichment to synchronize the individual measurements with the other related CE agents, the latency of the detection is at the lowest theoretical limit (i.e. information may not be passed more quickly from one CE agent to the other than in-band header enrichment as any out-of-band signalling needs to utilize the same physical network and links, with even increased overhead due to the lack of automatic context information carried in-band by the flow identification tuples).

The QoE degradations caused by congestion are either detected by the CE agent (in case they have already happened and show as visible impairments for the user) or predicted (in case within a short time frame the degradation occurs under the current circumstances). Prediction is possible in case of e.g. video download using progressive HTTP download (used by common video sites such as YouTube) by modelling the playout buffer of the UE and detecting that the amount of pre-buffered data is decreasing despite of UE being actively trying to download further data. The playout buffer is modelled by detecting the video attributes (duration, media rate) specific to the application session and tracking how much data is downloaded and acknowledged by the UE since the beginning of the download. Every time the playout buffer depletes, the video playback at UE stalls, causing QoE degradation. The degradations visible to UE are referred to as QoE incidents. The QoE incidents are application-specific. For web browsing, the QoE incidents are slow web page download or slow DNS resolution, for bulk data transfer, the QoE incidents are when the TCP suffers from multiple consecutive timeouts or the throughput drops below a required minimum rate. A user that is supposedly aborting a download due to QoE degradation is also a QoE incident. Any additional trigger for the QoE incident may also be implemented by the CE agents. The CE agent is automatically able to recognize, if the QoE problems are not caused by congestion but by other reasons such as UE limitations. The UE limitation is detected in case the QoE problems of a given UE correlate with small or zero TCP advertised window sent in the uplink TCP ACKs, indicating that the application at UE is not able to process the data as fast as the data is received.

In case transport congestion is detected, the available bandwidth on the bottleneck network segment is given by the cumulative throughput measurements of the connections that share the segment. The combination of the throughput measurement and the part of the delay measured above the intrinsic delay also defines the size of the network buffer before the bottleneck link. In case the CE agent has a topology database with the physical/logical links and their respective capacity that makes up the congested network segment, further localization is possible by selecting the link that has approximately the same capacity as the measured available throughput.

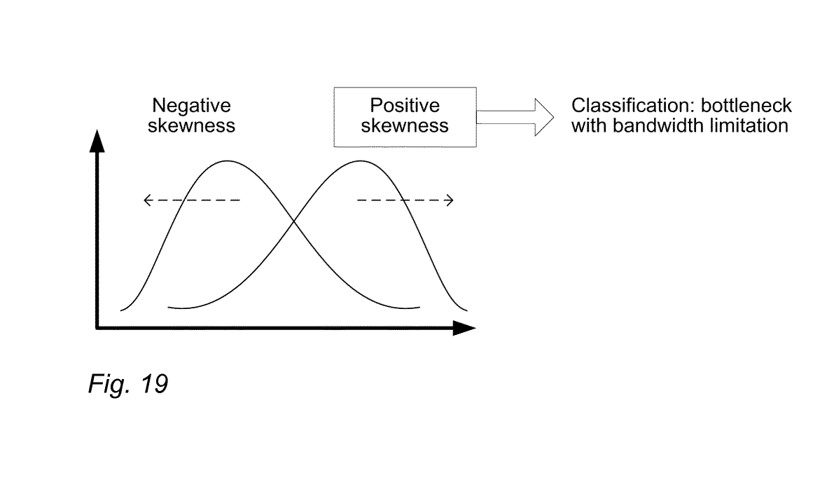

By analysing the delay, throughput and loss pattern, the CE agent may also detect, if there is a shaper or policer causing the limitation, and may also classify the bottleneck further. In case of a shaper, the momentary measured throughput may exceed the shaping rate due to allowing a burst to be transmitted before the throughput is throttled to the shaping rate. The discards are likely to occur after a period of increasing delay (as the buffer fills up) and they occur in bursts (due to buffer overflow). In case of a policer, those packets are discarded that do not fit into the configured policer rate. Thus the measured throughput after a policer element never exceeds a given threshold. The losses are more random and do not necessarily correlate with the delay build-up. The CE agent may also detect a buffer with a poorly configured AQM. The poorly configured AQM triggers a sustained level of sporadic random discards which prevent the buffer from adding significant queuing delay (thus keeping the delay on the network segment low) and at the same time prevent the TCP connections from reaching a high throughput as they are constantly forced into congestion avoidance. Besides the pattern of the delay, loss and throughput, the momentums and statistical parameters of the delay distribution are also monitored by the CE agent and used for bottleneck classification. In particular, the positive skewness (see FIG. 19 illustrating the skewness of the delay distribution) of the delay distribution is a good indicator of having a bottleneck link with a large buffer as it creates long queuing delay for the majority of the packets.

The frequency and intensity of the QoE incidents give a quantification of the severity or the impact of the congestion, which may be taken as a basis for deciding on countermeasures or corrective actions. The severity of transport congestion may also be quantized based on how much the higher priority traffic is impacted. Accurate localization (e.g. differentiating between radio and transport congestion) as well as the detection of individual problems or cell/eNB level problems, provided by the CE agent, is the prerequisite of selecting a proper action. QoE problems due to poor channel quality require focused actions dealing specifically with the impacted UEs (e.g. by media adaptation). Radio side congestion may be solved by bearer prioritization or demotion, or per-UE, per-application or per-flow bandwidth management. Transport congestion may require a congestion control action, or alternatively weight optimization at the transport schedulers, bandwidth management/shaper reconfiguration or capacity increase. When congestion is detected, the CE agent also calculates the optimal state including the desired bandwidth of the applications and the corresponding radio and transport configuration that enables reaching or approaching the optimum (i.e. bearer QoS parameters, weight configuration, shaper rate, capacity allocation, etc.). Knowing the difference between the current state and the optimal enables the CE agent to suggest or trigger proper network optimization actions with the right degree or amount of intervention, such as bearer prioritization, bandwidth throttling, transport service provisioning via SDN, or weight reconfiguration in a transport device. The CE agent is able to provide the information to external entities (congestion control mechanisms, network optimization or management engines, SDN controller, PCRF/PCEF, etc.) to trigger the action.

Additionally, the CE agent profiles the constellation of KPIs it collects. The result of the profiling is a set of states the network element or end-to-end context (e.g. S1/X2 interface) has had. This includes low load states, different types of high load states and congested states. Also node or context specific intrinsic parameters are collected such as the minimum delay or latency, the valid maximum delay values, and capacity under congestion. The latter may vary both on the radio interface and the S1 interface. The radio capacity is changing as the function of the user location and mobility, whereas the transport capacity under congestion may take different values, if eNB shares aggregation links with other network elements. The deviation from known KPI patterns/valid states (e.g. due to path switch or any other anomaly) is detected as well in order to enable sophisticated network and traffic management actions.

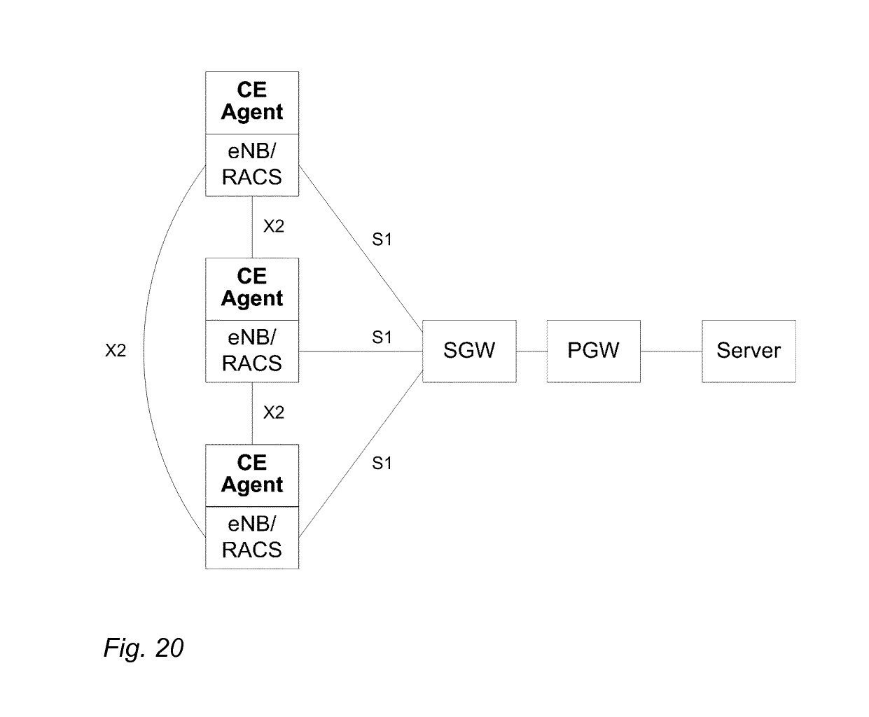

In an embodiment, deployment-specific architecture, operation and capabilities are disclosed. Implementation options may be provided for the cooperative measurements and real-time status updates via protocol header (e.g. TCP/IP/GTP) enrichment. There are multiple deployment options for the CE agent, resulting in different measurement scope, granularity and aggregation possibilities. Additionally, the architecture and operation of the CE agents (e.g. the source of information) may be specific to the deployment scenario. For example, LTE-related deployments and 3G BTS/RNC-specific implementation are disclosed. In LTE a possible deployment is that there are eNB side CE agents only (see FIG. 20 illustrating distributed radio side CE agent deployment), where the CE agent is running at or attached to eNB (e.g. implemented in BS, or as an application in RACS). The eNB/RACS side CE agent is individually able to monitor the radio side and the core side part of the network separately, as well as detect the X2 traffic and conduct collaborative measurements on the user plane packets forwarded via X2 (e.g. timestamp to measure the one-way X2 forwarding delay). Additionally, the CE agents may measure QoE of the application sessions individually.

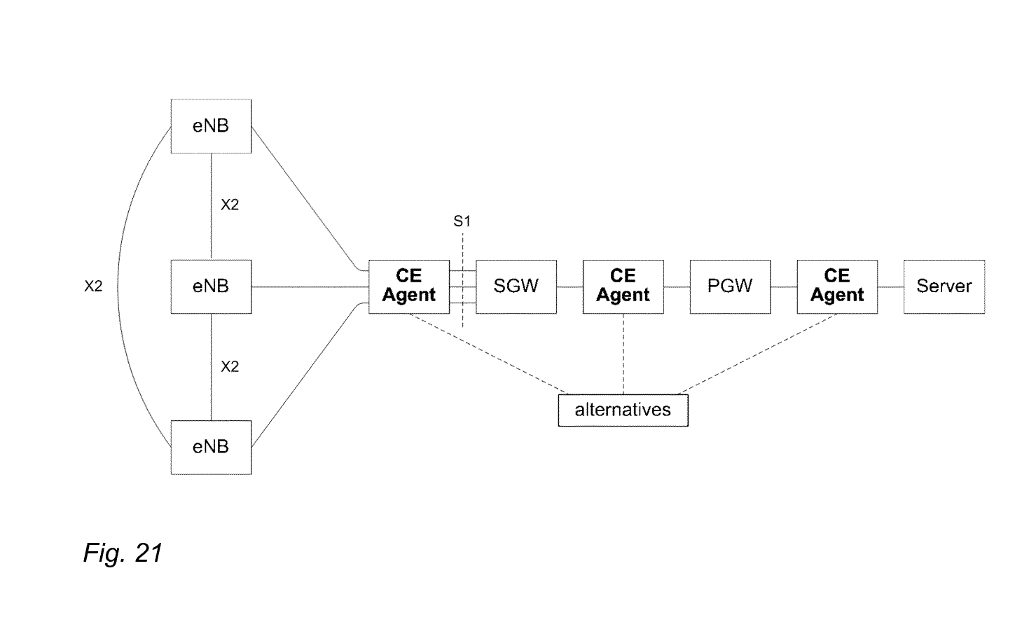

A core side standalone deployment is also a feasible alternative, when the CE agent is deployed as part of a core network element (e.g. SGW/PGW) or as a stand-alone middle box (see FIG. 21 illustrating the core side standalone CE agent deployment). The core side CE agent is able to measure the external network segment and the operator's network segment separately. The SGW side CE agent is also able to monitor the per-eNB traffic separately. Additionally, in case a network topology database is available or appropriate heuristics are used, the SGW side CE agent is able correlate measurements between eNBs and detect, if the congestion at multiple eNBs are related (e.g. due to shared transport network link), or due to individual last mile or radio side limitations.

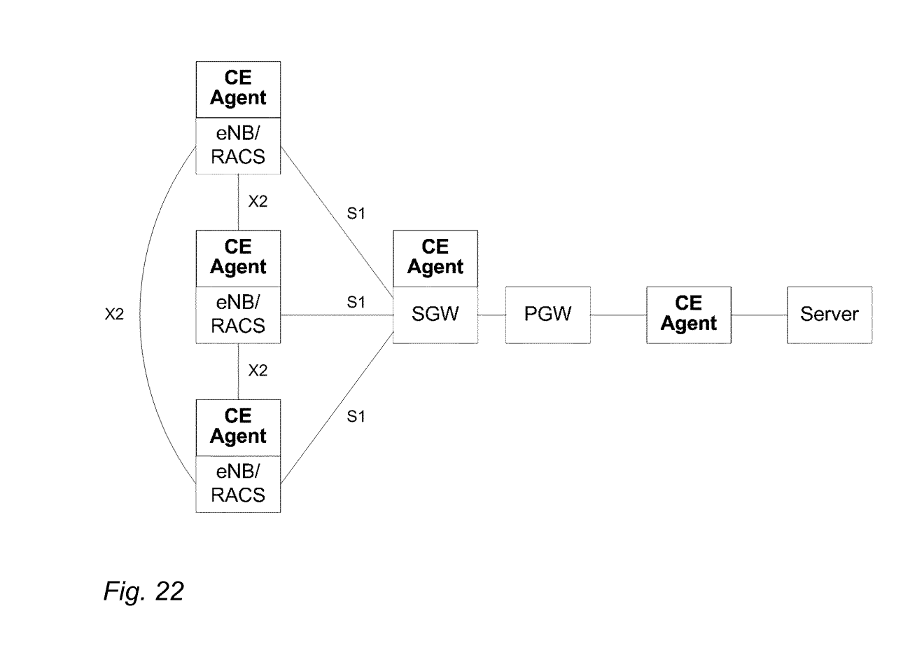

A combined deployment of the CE agent is to have per-eNB instances as well as core side elements (see FIG. 22 illustrating combined CE agent deployment). Due to the collaborative measurements between the CE agents, the measurements are created per eNB radio interface, X2 interface, S1 interface, for the core network segment and for the external network. The X2 related measurements (which are created at the CE agent monitoring the traffic at the target eNB) are sent upstream as part of the real-time CE agent status updates, therefore the core side instances have a view on the X2 segment as well, correlated with the other segments. The SGW side CE agent is also able to localize the bearers and UEs on the eNB level in real-time based on the eNB IP address that is part of the GTP/UDP/IP protocol stack on the S1 interface. Even in case IPsec is used on the S1 interface, the CE agent is still able to perform per-eNB per-DSCP measurements (based on the content of the outer IP address).

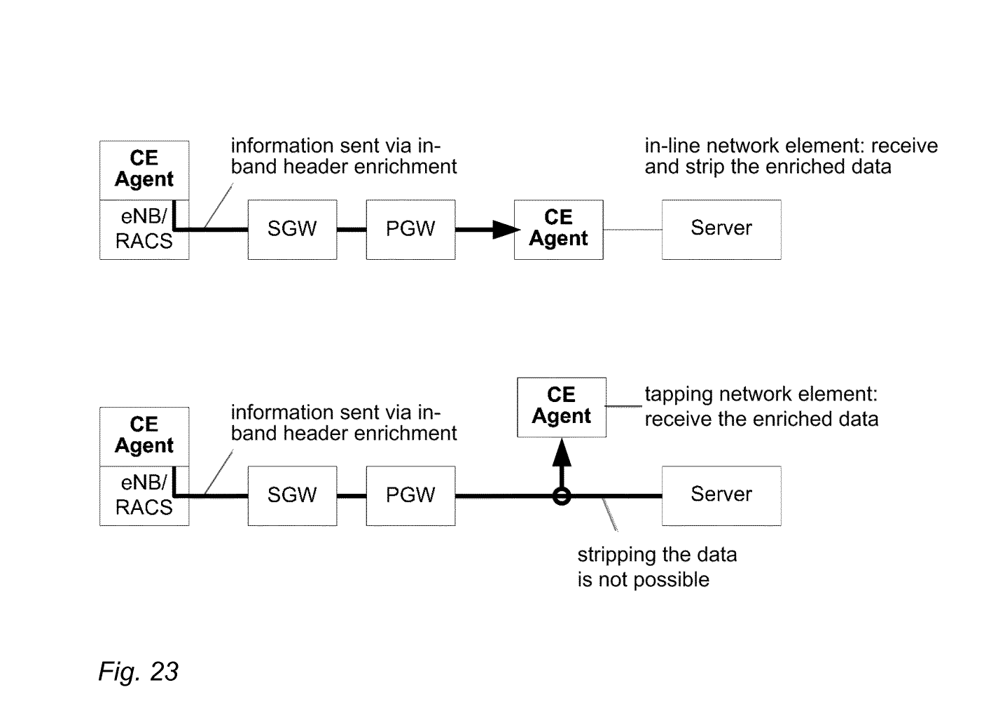

In a combined deployment, the eNB side CE agent is also able to detect the user mobility in real-time and provide the user location as a network side information to the core side CE agents or to any additional or external information receiver. In addition to location information, the eNB side CE agent may also transfer the bearer attributes (including a configuration local to the eNB, such as QCI weight (wQCI) configured to the bearer, as well as standard parameters, such as QCI/GBR/MBR of the bearer). FIG. 23 illustrates an in-line core side CE agent vs. a tapping core side CE agent. The core side CE agent may be an in-line network element, meaning that it is able to modify the packets (e.g. for in-band header enrichment), or a tapping network element which only receives a read-only copy of the data stream. The latter deployment may be relevant in case the operator is not inclined to include an additional network element on the core side. However, even in this case, the core side CE agent is still able to receive information efficiently in-band from the radio side CE agents and thus have a per-segment accuracy with the network.

In case the eNB side CE agent is implemented as an application in RACS, it has access to additional radio side information (e.g. radio channel quality, timing advance, etc.) as well as cell/sector level mobility and location information (explicit handover notification and global cell ID). The CE agent may transfer these pieces of information to the core network to enrich the core side CE agents or other entities with accurate radio side or location information.

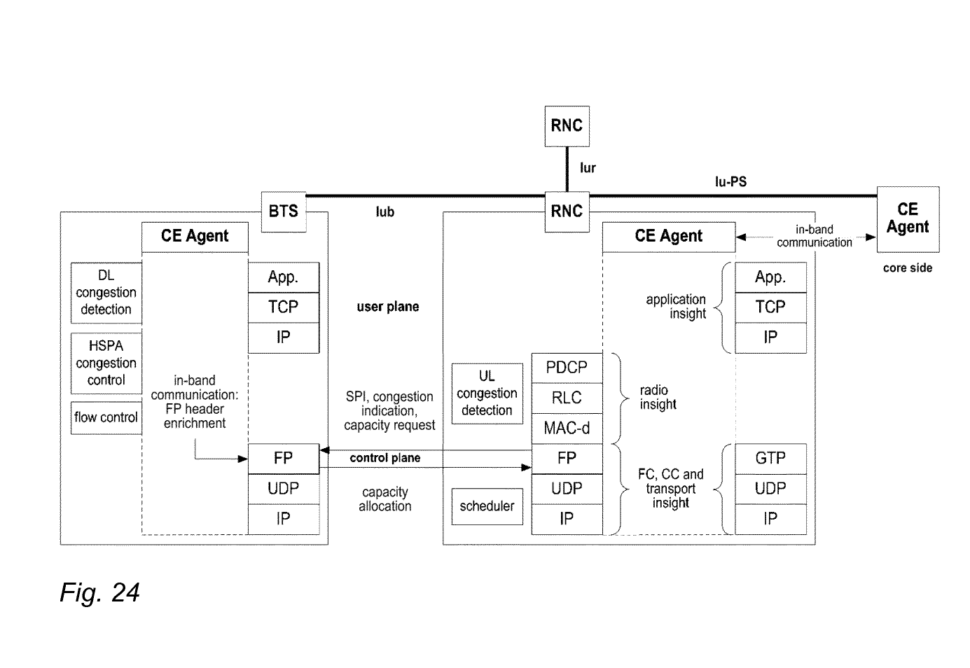

FIG. 24 illustrates a 3G BTS/RNC specific CE agent implementation. The CE agent may be located in the RNC, where it is able collect an insight on the user plane, on the radio side, as well as on the Iub and Iur transport. The BTS side CE agent is an optional counterpart that has a lightweight supporting role to enable collaborative measurement and upstream information from 3G BTS to the RNC side CE agent.

The RNC side CE agent is able to directly detect UL losses on the frame level by monitoring FSN of E-DCH data frames. Each E-DCH frame may carry multiple MAC-is PDUs. Therefore a single frame loss may indicate multiple MAC-is PDU losses. The DL losses are visible to the RNC side CE agent on the RLC protocol layer (in case an acknowledged mode is configured), indicated by negative acknowledgements in the status PDUs sent by the RLC AM entity of UE. However, the information on which portion of RLC PDU is lost is not available, therefore the granularity of the RLC-based DL loss detection is limited. Lost DL RLC PDUs are retransmitted by the RNC side RLC entity. In addition to packet losses, retransmissions occur also in case the RLC timer expires in RNC. These events may be recognized by the RNC side CE agent via detecting retransmissions of PDUs with no corresponding status PDUs (and thus negative ACK) received from the base station. The timer expiry indicates that the layer 2 RTT exceeds the timer interval. Thus there is an unusually large delay on the Iub. RLC reset messages may also be detected by the CE agent and they indicate complete radio protocol stack collapse for the corresponding UE. In case the reset only affects a single UE, this is likely due to an individual radio channel problem. If the resets occur simultaneously for a significant number of UEs in the same base station, there is likely a common anomaly (such as extreme Iub congestion). The 3G base station informs RNC on those PDUs that are discarded by the 3G base station itself via UL Drop indication messages. The contents of these PDUs are available at the 3G base station and indicated to RNC in the message. This source of information is available without the assistance of the 3G BTS side CE agent. In order to support a more accurate DL loss detection on the Iub transport, the 3G BTS side CE agent may detect HS-DSCH data frame loss via the FSN monitoring, and report the losses to the RNC side CE agent. The BTS and RNC side CE agents may efficiently communicate via header enrichment in the Iub frame protocol (using spare extensions). Each HS-DSCH frame may carry multiple MAC-d PDUs, therefore a single frame loss may indicate multiple MAC-d PDU losses.

The Iub node synchronization procedure may be utilized by the RNC side CE agent to obtain RTT on the Iub interface with each 3G BTS. During the procedure, RNC sends a DL node synchronization message, which carries an RNC specific time indication. This time indication is echoed by 3G BTS in an UL node synchronization message. The time difference between the reception of this UL message and the transmission of the original message at RNC provides an RTT measurement.

The 3G BTS side CE agent is able to detect delay increase or decrease (i.e. jitter) by monitoring DRT in the HS-DSCH data frames. DRT encodes the time when RNC transmitted the frame with a 1 ms precision. However, as DRT is only a relative counter and not an absolute timestamp, the 3G BTS side CE agent may only use them to calculate the difference between DRTs in the frames and to compare it to the measured inter-arrival time of the frames at the BTS. In case the measured inter-arrival time is higher than the difference between DRTs, there is a delay increase on the Iub interface in DL, otherwise the delay is decreasing. The arithmetic with DRT is done in modulo 40960. Accumulating the jitter over time may be used in 3G BTS to track the relative DL delay on the Iub interface. In case the 3G BTS side CE agent enriches the latest DRT received in the DL data frames into each UL E-DCH data frame (as a spare extension), the RNC side CE agent may have a high granularity Iub RTT measurement. Explicit one-way delay measurement on the Iub interface, however, requires that the clocks of the RNC and the eNB are synchronized and a timestamp is enriched into the header of the data frames by the RNC side CE agent (in DL) and the 3G BTS side CE agent (in UL).

The delay/jitter and loss measurements data collected from the FP layer at the MAC-d flow level, is to be correlated with the user plane traffic flows. The correlation is possible through E-RNTI (in E-DCH and HS-DSCH data frames) or dedicated H-RNTI (in the HS-DSCH data frame) temporary UE specific identities. E-RNTI and H-RNTI are allocated by RNC during a radio bearer setup procedure. The radio bearer (identified by RAB ID) carries the user plane traffic between RNC and UE. The radio bearer is connected to a core network (CN) bearer (identified by GTP TEID), carrying traffic between RNC and SGSN/SGW. In RNC, there is a one-to-one mapping between RAB ID and GTP TEID and also a mapping between E-/H-RNTI and RAB ID. In order to correlate the measurements originating from the FP layer with the UE IP flows, the mapping is maintained by the RNC side CE agent between the IP flows and the corresponding CN bearer. The mapping may be established by observing GTP TEID in the GTP header and UE IP in the inner IP header in the user plane packets arriving from the core network. The mapping enables the correlation of UE IP flows with FP layer measurements via a UE IP, GTP TEID, RAB ID, E-/H-RNTI indirection chain.

In RNC, the CE agent has access to RRM, including power control measurements and per UE radio channel status. The RNC side CE agent may also explicitly detect HARQ failures on DCH channels (and indication of poor radio channel quality for the corresponding user) via listening to HARQ failure indication messages, conveyed in E-DCH UL data frames from 3G BTS to RNC. The failure indication message carries information that enables the identification of the corresponding UE.

3G BTS has a flow control mechanism with the scope of preventing buffer overflow at BTS. Based on the status of the radio buffers, 3G BTS informs RNC on the amount of data it is allowed to send through the Iub interface. The information is quantized and represented as credits, either corresponding to MAC-d PDUs (TYPE-1 HS-DSCH data frames, fixed MAC-d PDU size) or data bytes (TYPE-2 HS-DSCH data frames, flexible MAC-d PDU size). Credits are allocated with the granularity of the flow priority (with 16 possible classes), referred to as a scheduling priority index (SPI), encoded as a CmCH-PI field in the Iub frames. The credits are conveyed to RNC via capacity allocation Iub control messages. In addition to the flow control mechanism, 3G BTS may also implement HSDPA congestion control. Congestion is detected in BTS via the detection of delay build-up and/or frame loss. Congestion mitigation is based on the same credit allocation mechanism and congestion results in the decrease of the credits. In that case, the capacity allocation messages convey the minimum of the credits allocated by either the flow control or the congestion control, i.e. the congestion control may reduce the credits beyond to the allocation of the flow control mechanism. Additionally, the capacity allocation messages also carry the DL congestion status as detected by the 3G BTS (no congestion, delay build-up or frame loss). The monitoring of the credit allocation enables the RNC side CE agent to detect radio interface congestion (in case credits are decreased without DL congestion indication) and the explicit detection of Iub DL transport congestion (according to the congestion indication). The credit allocations explicitly indicate the amount of available bandwidth on the Iub per each priority class. The UL Iub congestion is detected by RNC itself by monitoring delay and loss on the E-DCH data frames.

The CE agent also monitors Iur (i.e. the interface between RNCs) to detect inter-RNC soft handovers and SRNC relocation. Iur uses a frame protocol between a serving RNC (SRNC) and drift RNC (DRNC) similar to Iub FP, therefore the Iub measurement mechanisms discussed above are also applicable to the Iur interface.

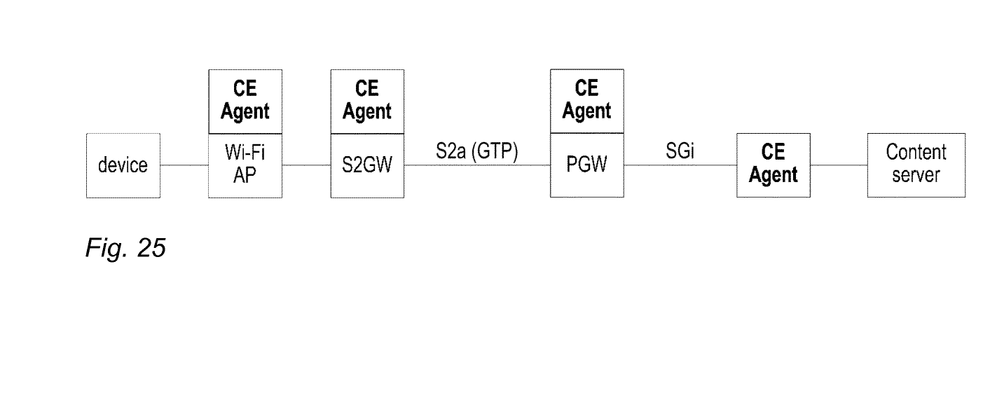

FIG. 25 illustrates a Wi-Fi-specific CE agent implementation. In case of Wi-Fi and 3GPP network integration, possible locations for the CE agent are Wi-Fi AP itself, S2GW, PGW, and the core network. S2GW terminates the GTP tunnel towards PGW on the S2a interface, and maintains a correlation between the user IP flows and the GTP tunnels (via UL TFTs signalled by PGW). The measurement between the CE agent in S2GW and PGW are similar to the measurements on the also GTP based LTE S1 interface. The Wi-Fi AP side CE agent is able to perform measurements on the user IP flow level, which may be collected and correlated with the GTP based measurements by the S2GW CE agent.

In an embodiment, in an enrichment implementation, the communication for collaborative measurements and real-time status update may be performed via in-band header enrichment of the user plane packets. This is an efficient mechanism to exchange information related to the user plane connections themselves, as the whole context of the information (e.g. flow identity, timing, etc.) is natively carried by the packet itself. The protocol headers suitable for enrichment are TCP and/or IP in the user plane, both enabling the usage of the option field (additional 40 bytes, shared by each application doing header extension). Reserved bits or the IP DSCP field may also be used if it does not collide with other use cases. Additionally, the RTP header also provides standard means to include additional information which covers the majority of the UDP data traffic that has practical relevance. On the S1/S5/S2a interfaces, the GTP-U packets may also be enriched with additional information via the standard GTP extension mechanism. On the Iub/Iur interfaces, the frame protocol provides an efficient mechanism to include additional data into the headers in the form of so-called spare extensions, which is preferred over IP header enrichment due to its processing overhead in the routers.

Regardless of the enriched protocol header, the enrichment (and the changes consequently required in the various protocol fields, such as sizes, offsets, checksums) may be performed partly or entirely in hardware or firmware (e.g. on a network card or on a dedicated network processor) for higher efficiency.

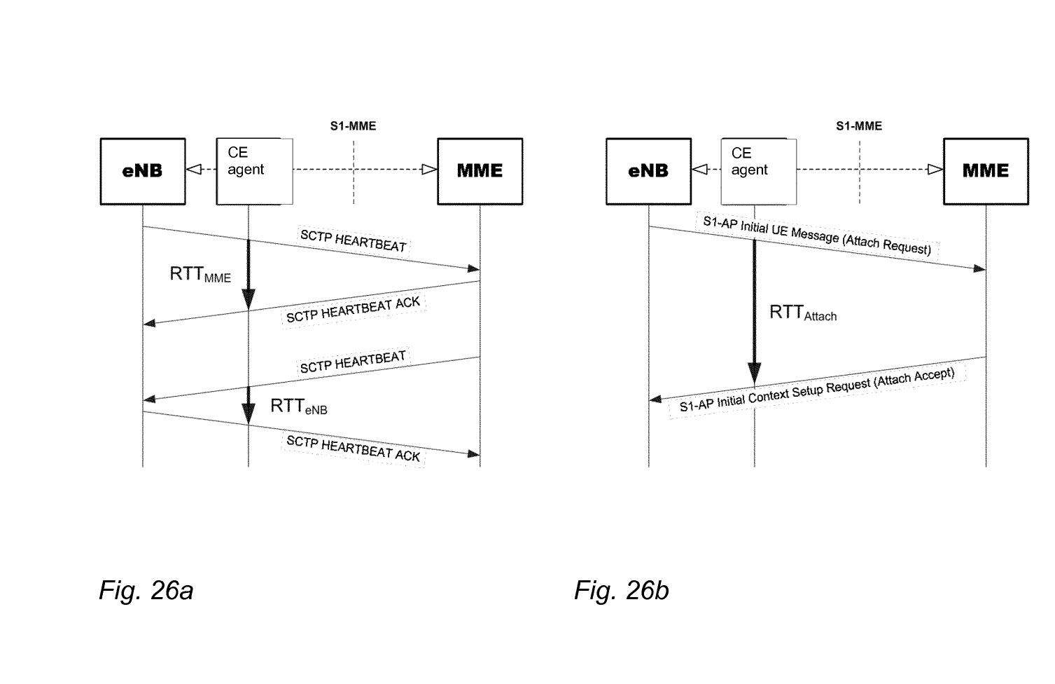

In an embodiment, control plane measurements are carried out. The capabilities of the CE agent may include packet monitoring on the control plane. FIG. 26 illustrates control plane measurements on the LTE S1-MME interface. In case the CE agent is deployed at a location where it has access to the control plane packets exchanged between eNB and MME (S1-MME interface), or between SAE-GW and MME (S11 interface), the CE agent is able to perform QoS measurements on the control plane packets. On the SCTP-based S1-MME interface, the SCTP level HEARTBEAT and HEARTBEAT ACK messages may be used to measure the control plane RTT both towards eNB and MME, as illustrated in FIG. 26a. These SCRP messages do not carry any S1-AP message part, therefore the measured RTTs do not depend on the control plane processing load in eNB and MME. By measuring RTT using a control plane message exchange that carries S1-AP messages, it is possible to obtain the control plane RTT that depends on the processing load of the network elements and additional signalling overhead. In addition to measuring control plane RTTs, the CE agent is able to parse the per bearer QoS parameters (QCI, ARP, GBR in DL/UL, MBR in DL/UL, UE-AMBR in DL/UL) from the intercepted S1-AP initial context setup request message send by MME to eNB. Measuring how long it takes for UE to attach to the network and establish its default bearer requires measuring of the latency between the S1-AP initial UE message (attach request) and the S1-AP initial context setup request (attach accept) messages (see FIG. 26b). In order to differentiate between multiple ongoing parallel attach procedures, the identification of the corresponding messages is based on eNB UE S1AP ID which uniquely identifies the UE association over the S1 interface within eNB.

The correlation of the control plane performance (e.g. the completion time of the connectivity or other signalling procedures) with QoE measured for the applications transmitting data after the bearer is completed, enables to obtain a holistic QoE of the user. In case the connectivity to the network takes a long time to complete, the overall QoE of the user may still be poor, even if the user plane performance and the QoE of the data applications is good afterwards. In this case, the correlation of the user plane and control plane measurements provides the reason of the overall QoE degradation. The root cause may also be derived automatically by checking for which control plane transaction, message exchange takes unusually long time to complete, or which network element replies with a long response time. Measuring the minimum response time may provide the intrinsic latency of the control plane procedures that may be expected in the network that is not loaded from signalling point of view. Evaluating the delays in the context of delay profiles built from measurements or against QoS targets is a possibility to detect procedures that are possibly successful but longer-than-usual to complete to catch early signs of control plane overload before the high load leads to discarded connections.

An embodiment enables providing a relevant set of end-to-end as well as localized KPIs in an application agnostic, multi-vendor and efficient way, supporting a variety of network deployments and technologies. The contextual, correlated real-time evaluation of multiple KPIs enables automatic problem localization and root cause analysis. Additionally, the combination of the network side measurements with QoE of the applications enables QoE management and QoE-based network operation. A real-time, correlated insight into the user behaviour is provided, as well as the attributes of the application sessions, the customer experience and the network status (both local and end-to-end) through the collection of relevant user, application and QoE specific data and KPIs (such as user actions, application specific metadata, download time, application level latency, video staling, time to play, etc.) and QoS KPIs (such as throughput, RTT, delay, jitter, packet loss, TCP timeouts, packet discard patterns, etc.). The KPIs are derived from low-cost, in-band, transport technology agnostic application layer measurements executed at appropriate locations where the user plane packets may be intercepted. An entity referred to as the customer experience (CE) agent is provided. The CE agent may e deployed as LTE eNB, RACS, HSPA+ BTS, 3G BTS, RNC, SAE-GW, or a standalone network element in the core network (deployed on the S1, Gn, Gi or SGi interfaces).

Multiple use cases are supported, including but not limited to the following. Real-time application detection, user behaviour, application specific and QoE measurements are provided at data flow, application session level and at any higher aggregation (cell, eNB, coverage area, RNC, etc.) level. QoE is assessed through dedicated KPIs that capture the relevant information for each application, such as the time to play and the number/duration of stalling for video, download time and latency for web and chat applications, etc. Additionally, the user behaviour is also monitored in context (such as cancelling download or refreshing a partially downloaded web page).

CEM analytics is provided through the collection of QoE KPIs and contextual information on the root cause of the detected QoE degradations.

An enhanced anomaly detector is provided by correlating the insights obtained from the user level, application specific QoE and QoS measurements, congestion detection and localization, bottleneck classification, etc.

Network monitoring/operation and troubleshooting are provided. The generated QoS/QoE insight is channelized to network operational tools, dashboards/visualization, alarming/reporting system, customer care, marketing, etc.

The QoS measurements are provided, representing a superset of those required by legacy QoS driven solutions (RTT, delay target, loss, throughput, etc.). Therefore traditional legacy QoS based triggers are also enabled, such as delay/loss threshold based alarms/actions.

Services are provided to other advanced mechanisms for improving the efficiency of data transfer or for managing QoE, QoS, load, efficiency, etc. such as TCP optimisation, dynamic QoS management, bandwidth management/enforcement, media adaptation, self-organizing network use cases (e.g. MLB), transport SON (Tra-SON), traffic steering/Wi-Fi offload, congestion control, etc.

Proper bandwidth management and QoS/QoE enforcement are provided building on the correlation of the ongoing application sessions, their demand or bandwidth requirement, the network status, congestion detection and localization, etc. Collecting insight and measurements data already at individual flow level, enables non-intrusive TCP optimization mechanisms (e.g. AWND management, ACK shaping) without terminating the TCP traffic (i.e. without being a TCP proxy).

In an embodiment, correlated measurements over multiple TCP connections and HTTP objects (e.g. to track down the progress of a web page download over a modern multi-threaded web browser), and the correlation of various application layer protocols (e.g. DNS resolution and HTTP latency, both influencing the user experience of the same web page download) are carried out. Measurements data are collected and delivered on each application protocol layer in a correlated way, natively providing the linkage between related measurements both vertically (across application protocols) and horizontally (within the same application protocol).

A mechanism is disclosed for UPCON congestion detection as well. An insight is provided into the user plane applications, capable of correlation detection among different flows or even among different packets of the same flow. QoE measurements and their enablers (e.g. HTTP latency) and TCP RTT are delivered continuously.

The user plane packets themselves are utilizes for executing the measurements, requiring no additional test traffic and also no dedicated control sessions to negotiate the measurements. By executing the measurements on top of the user plane packets, the results directly correspond to the real traffic of interest and not to artificially generated and unrelated test traffic. Also, automatic measurements are performed, corresponding to the relevant PHBs (i.e. that are actively used), self-adopting itself to the network setup and its changes without the need for any configuration. The additional data enriched into the protocol headers is limited compared to the full size of the packets, thus there is low overhead in terms of additional data.

The congestion detection mechanism is applicable to any network (including existing HSPA systems as well) in any conditions.

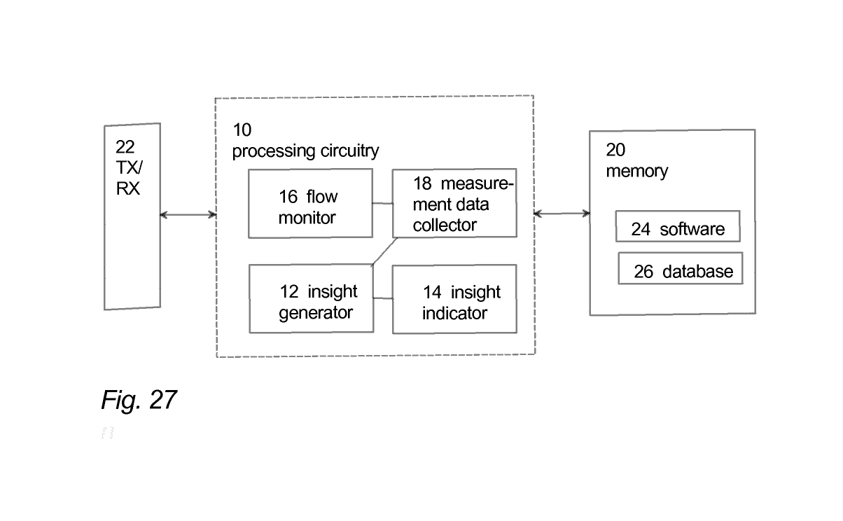

An embodiment provides an apparatus comprising at least one processor and at least one memory including a computer program code, wherein the at least one memory and the computer program code are configured, with the at least one processor, to cause the apparatus to carry out the procedures of the above-described network element or the network node. The at least one processor, the at least one memory, and the computer program code may thus be considered as an embodiment of means for executing the above-described procedures of the network element or the network node. FIG. 27 illustrates a block diagram of a structure of such an apparatus. The apparatus may be comprised in the network element or in the network node, e.g. the apparatus may form a chipset or a circuitry in the network element or in the network node. In some embodiments, the apparatus is the network element or the network node. The apparatus comprises a processing circuitry 10 comprising the at least one processor. The processing circuitry 10 may comprise a flow monitor 16 configured to monitor a user plane traffic flow transmitted in a network, to perform measurements on selected data packets. The processing circuitry 10 may further comprise a measurement data collector 18 configured to collect, based on the monitoring, in a correlated way one or more of user measurement data, application measurement data, quality of experience measurement data, network-side quality of service measurement data and a set of key performance indicators. The measurement data collector 18 may be configured to perform correlated collection, as described above, and output information on the collected data/indicators to an insight generator 12, wherein the insight generator 12 is configured to generate real-time correlated insight to customer experience. The apparatus may further comprise an insight indicator 14 configured to indicate, to a network operator and/or to another network node, the generated real-time correlated insight to customer experience.

The processing circuitry 10 may comprise the circuitries 12 to 18 as sub-circuitries, or they may be considered as computer program modules executed by the same physical processing circuitry. The memory 20 may store one or more computer program products 24 comprising program instructions that specify the operation of the circuitries 12 to 18. The memory 20 may fur-ther store a database 26 comprising definitions for traffic flow monitoring, for example. The apparatus may further comprise a communication interface (not shown in FIG. 27) providing the apparatus with radio communication capability with the terminal devices. The communication interface may comprise a radio communication circuitry enabling wireless communications and comprise a radio frequency signal processing circuitry and a baseband signal processing circuitry. The baseband signal processing circuitry may be configured to carry out the functions of a transmitter and/or a receiver. In some embodiments, the communication interface may be connected to a remote radio head comprising at least an antenna and, in some embodiments, radio frequency signal processing in a remote location with respect to the base station. In such embodiments, the communication interface may carry out only some of radio frequency signal processing or no radio frequency signal processing at all. The connection between the communication interface and the remote radio head may be an analogue connection or a digital connection. In some embodiments, the communication interface may comprise a fixed communication circuitry enabling wired communications.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described above in connection with FIGS. 1 to 27 may also be carried out in the form of one or more computer process defined by one or more computer programs. The computer program shall be considered to encompass also a module of a computer programs, e.g. the above-described processes may be carried out as a program module of a larger algorithm or a computer process. The computer program(s) may be in source code form, object code form, or in some intermediate form, and it may be stored in a carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to cellular or mobile communication systems defined above but also to other suitable communication systems. The protocols used, the specifications of cellular communication systems, their network elements, and terminal devices develop rapidly. Such development may require extra changes to the described embodiments. Therefore, all words and expressions should be interpreted broadly and they are intended to illustrate, not to restrict, the embodiment.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

3GPP 3rd Generation Partnership Project

AMBR Aggregated Maximum Bit Rate

AP Access Point

ARP Allocation and Retention Priority

BTS Base Station

CDN Content Delivery Network

CE Customer Experience

CE-A Customer Experience agent (CE agent)

CEM Customer Experience Management

CmCH-PI Common Channel Priority Indicator

CN Core Network

CSV Comma Separated Values

DL Downlink

DRT Delay Reference Time

DSCP Differentiated Services Code Point

ECGI Evolved Cell Global Identifier

eNB Evolved Node B

FCO Flexi Content Optimizer

FP Frame Protocol

FSN Frame Sequence Number

FTP File Transfer Protocol

GBR Guaranteed Bit Rate

GPRS General Packet Radio Service

GPS Global Positioning System

GTP GPRS Tunnelling Protocol

HE Header Enrichment

HSDPA High Speed Downlink Packet Access

HSPA High Speed Packet Access

HSUPA High Speed Uplink Packet Access

HTTP Hypertext Transfer Protocol

HTTPS Hypertext Transfer Protocol Secure

IMSI International Mobile Subscriber Identity

IP Internet Protocol

ISP Internet Service Provider

KPI Key Performance Indicator

LTE Long Term Evolution

MBR Maximum Bit Rate

MME Mobility Management Entity

MSS Maximum Segment Size

NTP Network Time Protocol

OWAMP One Way Active Measurement Protocol

PCEF Policy and Charging Enforcement Function

PCRF Policy and Charging Rules Function

PHB Per-Hop Behaviour

PTP Precision Time Protocol

QoE Quality of Experience

QoS Quality of Service

RACS Radio Application Cloud Server

RACS-C RACS in the Core

SDN Software Defined Networking

RNC Radio Network Controller

SPI Scheduling Priority Index

RRC Radio Resource Control

RTT Round Trip Time

SAE-GW Service Architecture Evolution Gateway

SCTP Stream Control Transmission Protocol

SON Self Organizing Network

TCP Transmission Control Protocol

TFT Traffic Flow Template

TLS Transport Layer Security

TWAMP Two Way Active Measurement Protocol

UDP User Datagram Protocol

UE User Equipment

UL Uplink

UPCON User Plane Congestion Management

VoIP Voice over IP

VoLTE Voice over LTE

VPN Virtual Private Network

1.-44. (canceled)

45. A method for generating insight to customer experience, the method comprising:
monitoring, in a network node, a user plane traffic flow transmitted in a network, to perform measurements on selected data packets;
based on the monitoring, collecting, in the network node, in a correlated way real-time data comprising one or more of user measurement data, application measurement data, quality of experience measurement data, network side quality of service measurement data and a set of key performance indicators, wherein the collecting in the correlated way means that in one measurement round the real-time data is collected from either a packet or a packet and corresponding one or more response packets so that each piece of the real-time data collected in the correlated way correspond to current network condition in real-time;
based on the collecting in the correlated way, generating, in the network node, real-time correlated insight to customer experience.

46. The method of claim 45, further comprising:
associating, in the network node, each user plane traffic flow with a user device and an application.

47. The method of claim 45, further comprising:
updating, in the network node, a set of key performance indicators in response to detecting a relevant event related to the user plane traffic flow based on collected real-time measurement data.

48. The method of claim 47, wherein
the relevant event comprises one or more of packet arrival, packet retransmission, packet discard, out-of-order segment transfer, and data transfer.

49. The method of claim 45, further comprising:
collecting real-time QoS measurement data on TCP traffic and UDP traffic.

50. The method of claim 45, further comprising:
based on the collecting, determining and indicating a network side reason for degradation in quality of experience.

51. The method of claim 45, further comprising:
carrying out QoS measurements at one or more QoS measurement points within an end-to-end path of the user plane traffic flow.

52. The method of claim 45, further comprising:
exchanging at least one of status information and QoS measurement information between QoS measurement points.

53. The method of claim 45, further comprising:
providing information on the insight to customer experience to one or more of: a network operator and another network node.

54. The method of claim 45, further comprising:
aggregating flow level QoS measurement data to a higher level QoS measurement data, such as application level QoS measurement data, user level QoS measurement data, or cell level QoS measurement data.

55. The method of claim 45, wherein
the set of key performance indicators comprises one or more of user-related QoS key performance indicators, application-related QoS key performance indicators, quality of experience-related QoS key performance indicators, and network status-related QoS key performance indicators.

56. The method of claim 45, further comprising:
performing correlated user plane anomaly detection to identify degradation in quality of experience caused by one or more of congestion and transport link bottlenecks.

57. The method of claim 45, further comprising:
performing monitoring of control plane performance in correlation with user plane application quality of experience.

58. The method of claim 45, further comprising at least one of the following:
performing congestion detection based on a correlation of measured quality of experience degradation;
performing network status detection based on at least one of loss pattern detection, delay profile analysis and correlated delay-loss-throughput profiling and classification; and
determining the typical behaviour of a communication instance, and detecting a deviation from the typical behaviour.

59. The method of claim 45, further comprising:
monitoring the header content of data packets;
recording the time when the data packets are intercepted; and
optionally adding or removing additional header fields by header enrichment.

60. The method of claim 45, wherein
if a data packet is intercepted at a first measurement point, with a header enriched at a second measurement point, the method comprises decoding and combining received measurements data with measurements data of the first measurement point as well as measurements data received from other measurement points, in order to update per-network-segment key performance indicators.

61. The method of claim 45, wherein the method comprises monitoring RTT of TCP connections by at least one of
measuring the time between the observation of a TCP data segment in TCP header, and a relevant acknowledgement transmitted in an opposite direction, and
measuring the time between a duplicate acknowledgement sent by a TCP receiver and a first retransmission originated from a TCP sender.

62. The method of claim 45, wherein the method comprises measuring HTTP level RTT by measuring the time between corresponding HTTP request and HTTP response messages.

63. An apparatus comprising:
at least one processor; and
at least one memory including a computer program code, wherein the at least one memory and the computer program code are configured, with the at least one processor, to cause the apparatus to
monitor a user plane traffic flow transmitted in a network, to perform measurements on selected data packets;
based on the monitoring, collect in a correlated way real-time data comprising one or more of user measurement data, application measurement data, quality of experience measurement data, network side quality of service measurement data and a set of key performance indicators, wherein to collect in the correlated way means that in one measurement round the real-time data is collected from either a packet or a packet and corresponding one or more response packets so that each piece of the real-time data collected in the correlated way correspond to current network condition in real-time;
based on the collecting, generate, by using the real-time data collected in the correlated way, real-time correlated insight to customer experience.

64. The apparatus of claim 63, wherein the at least one memory and the computer program code are further configured, with the at least one processor, to cause the apparatus to
associate each user plane traffic flow with a user device and an application.

65. The apparatus of claim 63, wherein the at least one memory and the computer program code are further configured, with the at least one processor, to cause the apparatus to
update a set of key performance indicators in response to detecting a relevant event related to the user plane traffic flow based on collected real-time measurement data, wherein
the relevant event comprises one or more of packet arrival, packet retransmission, packet discard, out-of-order segment transfer, and data transfer.

66. A computer program product embodied on a non-transitory distribution medium readable by a computer and comprising program instructions which, when loaded into the computer, execute a computer process comprising causing a network node to
monitor network side user plane traffic flow, to perform measurements on selected data packets;
based on the monitoring, collect in a correlated way real-time data comprising one or more of user measurement data, application measurement data, quality of experience measurement data, network side quality of service measurement data and a set of key performance indicators, wherein to collect in the correlated way means that in one measurement round the real-time data is collected from either a packet or a packet and corresponding one or more response packets so that each piece of the real-time data collected in the correlated way correspond to current network condition in real-time;
based on the collecting, generate, by using the real-time data collected in the correlated way, real-time correlated insight to customer experience.
